(19) United States
(12) Patent Application Publication
(10) Pub. No.: US 2007/0029924 A1
(43) Pub. Date: Feb. 8, 2007

(54) Image display device

(76) Inventors: Nobuyuki Ushifusa, Yokohama (JP); Nobuhiko Fukuoka, Ebina (JP); Shigeru Matsuyama, Mobara (JP); Hiroshi Kawasaki, Ooami-Shirasato (JP); Chikae Kubo, Mobara (JP); Akira Ishii, Mobara (JP); Hiroshi Kikuchi, Zushi (JP); Takuo Tamura, Yokohama (JP); Yasushi Sano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/498,136

(22) Filed: Aug. 3, 2006

(30) Foreign Application Priority Data
Aug. 26, 2005 (JP) 2005-246510
Aug. 3, 2005 (JP) 2005-225002

(51) Int. Cl. H01J 63/04; H01J 1/62

(52) U.S. Cl. 313/496

(57) ABSTRACT

An image display device according to the present invention comprises a back panel on which a plurality of pixels each having a thin film electron emitter are arranged two-dimensionally, a front panel disposed opposite the back panel on which phosphor layer is formed, and a sealing frame with which the back panel and the front panel are fixed mutually to seal the plurality of pixels and the phosphor layer in a space enclosed by the back panel, the front panel, and the sealing frame, and is characterized in that double-layered signal lines each electrically connected to a group of the plurality of pixels are formed on the back panel, each of the double-layered signal lines consists of a lower-level electrode made from a silver paste and an upper-level electrode covering at least a part of the lower-level electrode laminated in this order on the back panel. The lower-level electrode is shaped e.g. by coating a groove formed in a surface of the back panel with the silver paste, and a surface of the upper-level electrode is used e.g. for an electrode of the thin film electron emitter, also. According to the configuration, the present invention reduces wiring resistance of the signal lines each electrically connected to the thin film electron emitters as well as improves planarity of each tunneling junction of the thin film electron emitters to suppress dispersion of electron emission property thereof among the pixels.

The present application claims priority from Japanese applications JP2005-225002 filed on Aug. 03, 2005 and JP2005-246510 filed on Aug. 26, 2005, the contents of which are hereby incorporated by reference into this application.

### BACKGROUND OF THE INVENTION

1. Field of the Invention

The present invention relates to a flat panel type image display device, and in particular to an image display device having a back panel wherein thin film type emitters are arranged in the shape of a matrix on the principal surface of an insulating substrate, and a front panel provided with an anode plate which accelerates an electron beam emitted from the emitters and phosphors which emit light of a predetermined color due to excitation by the accelerated electron beam.

2. Description of the Related Art

One type of self-luminous flat panel display device having emitters in a two-dimensional matrix arrangement known in the art is a FED (Field Emission Display) which uses a field emission type panel employing very small, integrated cold cathodes. In this FED, the cold cathodes of the thin film emitters may be of various types, i.e., a Spindt type, surface conduction type, carbon nanotube type, MIM (Metal-Insulator-Metal) type having a metal-insulator-metal laminate, MIS (Metal-Insulator-Semiconductor) type having a metal-insulator-semiconductor laminate, or metal-insulator-semiconductor-metal type.

An MIM type emitter is disclosed in, for example, Patent document 1 and Patent document 2. An example of a metal-insulator-semiconductor type emitter is the MOS type disclosed in Nonpatent document 1, and an example of a metal-insulator-semiconductor-metal emitter is the HEED type emitter disclosed in Nonpatent document 2, the EL type emitter disclosed in Nonpatent document 3, or the porous silicon type emitter disclosed in Nonpatent document 4. An image display device is assembled by combining a panel provided with these emitters with a drive circuit.

FIG. 43 is a diagram showing the 1-pixel display principle of a display panel in an image display device using MIM type emitters. This display panel includes a back panel PNL1 and front panel PNL2 stuck by a sealing frame, not shown (using glass frit), and the inner space thereof is kept under vacuum. The back panel PNL1 for example has signal lines (i.e., data lines) d which are the lower electrodes of the emitters. Each of these preferably consists of an aluminum Al film on the principal surface (inner surface) of a back panel substrate SUB1 such as a glass plate or the like, a first insulating layer INS1 which is an anodized film formed by anodizing the aluminum of the lower electrode, a second insulating layer INS2 which is preferably a silicon nitride film (SiN), and a power supply electrode (contact electrode) ELC. It also has scanning lines s which are preferably of aluminum Al or aluminum alloy, each of which has upper electrodes AED which are the emitters of the pixels connected to the scanning line s.

Each emitter, wherein the data line d is a lower electrode, includes a thin filmpart INS3 forming part of the first insulating layer INS1 on the lower electrode d, and part of the upper electrode AED laminated on an upper layer of the thin film part INS3. The upper electrode AED covers the scanning line s and part of the contact electrode ELC. The thin film part INS3 is known as a “tunnel film”. This structure forms a “diode emitter”.

The front panel PNL2, on the other hand, has phosphors PH separated from adjacent pixels by a black matrix BM, and an anode plate AD which is preferably an aluminum-evaporated film (e.g. an aluminum chemical vapor deposition film) on the principal surface of a front panel substrate SUB2, preferably a transparent glass plate.

The interval between the back panel PNL1 and front panel PNL2 is about 3 to 5 mm, this interval being maintained by a spacer SPC which is also referred to as a septum. The plate thicknesses of the back panel substrate SUB1 and front panel substrate SUB2 are about 2.8 mm, and the height of the spacer SPC may be, for example, about 3 mm. In FIG. 43, for easier understanding, the thickness of each component layer is emphasized, and the thickness of the scanning line s may be for example 3 μm.

In such a structure, if an accelerating voltage (about 2 or 3 kV to 10 kV, in FIG. 43 about 5 kV) is applied between the upper electrodes AED of the back panel PNL1, and the anode plate AD of the front panel PNL2, a number of electrons e⁻according to the display data supplied to the data line d which is the lower electrode are emitted, and collide with the phosphors PH due to the acceleration voltage. The phosphors PH excited by the impact of the electrons e⁻emit light L of predetermined frequency to the exterior of the front panel PNL2. In a full color display, the unit pixel is a color sub-pixel, one color pixel normally having three sub-pixels, red (R), green (G) and-blue (B).

FIG. 44 is a diagram of the voltage-electrical current characteristics of the diode emitter described in FIG. 43. The MIM emitter is a tunnel diode. The threshold voltage is in the vicinity of 5V, a tunneling current occurs in the range beyond this threshold voltage, and this tunneling current increases with the increase in applied voltage.

FIG. 45 is a perspective view of a whole panel forming a full color image display device. In the back panel PNL1, plural scanning lines s extend in one direction and are arranged side by side in another direction intersecting perpendicularly therewith on the principal surface of the back panel substrate SUB1, which is the first substrate, scanning signals being applied sequentially in this other direction, plural data lines d extend in the other direction and are arranged side by side in the first direction so as to intersect with the scanning signal lines s, and emitters ELS are provided at each intersection between the scanning signal lines s and data lines d. In the front panel PNL2, there are three sub-pixels PH in the three colors (red (R), green (G), blue (B))which are mutually separated by the black matrix BM on the principal surface of the front panel substrate SUB2 which is a second substrate, and the anode AD. In this structure, the spacer SPC is installed along one of the scanning signal lines s of the back panel PNL1, and the two panels are sealed by a sealing frame, not shown, leaving a predetermined gap therebetween.

FIG. 46 is a plan view of the emitters on the back panel PNL1 shown in FIG. 45, and shows three emitters corresponding to the three sub-pixels of FIG. 45. FIG. 47 is a cross-sectional view along a line A-A′ of FIG. 46. FIG. 48 is a cross-sectional view along a line B-B′ of FIG. 46. In FIG. 47 and FIG. 48 which show the cross-sectional structure of an emitter, the data line d which is aluminum or an aluminum alloy (for example, aluminum and neodymium (aluminum+Nd)), is formed on the principal surface of the back panel substrate SUB1. This data line d is anodized to form the first insulating film INS1 and third insulating film INS3. The contact electrode ELC, which is preferably of chromium (Cr), and the scanning lines which is preferably of aluminum, are formed via the second insulating film INS2 of silicon nitride (SiN) on the first insulating film INS1.

In FIG. 46, the scanning lines s1, s2, . . . are formed so as to intersect the data lines d1, d2, d3, . . . in the up/down direction of the diagram. As shown in FIG. 47 and FIG. 48, the data line d (d1, d2, d3, . . . ) is the lower electrode, the scanning line s (s1, s2, . . . ) is the upper electrode AED which is connected through the contact electrode ELC, and the insulating layer INS3 which is the thin film part of the first insulating layer INS1 is sandwiched between the lower electrode and upper electrode. In FIG. 48, the upper electrode AED is not shown.

This emitter ELS has an opening EMA, electrons being emitted at the boundary of the opening which exposes the third insulating film INS3, i.e., the thin film part of the insulating film INS2, and the third insulating film INS3 has an electron emission region EMT situated further inside than this opening EMA. In FIG. 46, the size of the emitter opening EMA in the extension direction of the data lines is D1, and the size of the electron emission region EMT is D2. The intersection regions between the data lines d and scanning lines s including the electron emission region EMT, are considered to be electron emission regions.

Patent document 3 discloses a hollow shape in the emitter of the image display device. However, the image display device disclosed by Patent document 3 has a focusing electrode, and converges the electron beam from a cathode.

The patent documents and the non-patent documents each referred above or later are listed as follows.

[Patent Document 1] Japanese Patent Laid-open Publication (referred to as JP-A, hereinafter) No. 1995-65710 (JP 07065710 A)

[Patent Document 2] JP-A-1998-153979 (JP 10153979 A)

[Patent Document 3] JP-A-2002-016915 (JP 2002016915 A)

[Non-patent Document 1] K. Yokoo, et al, “Emission characteristics of metal-oxide-semiconductor electron tunneling cathode, “J. Vac. Sci. Techonol. B11 (2) pages 429-432 (1993)

[Non-patent Document 2] N. Negishi et al, “High Efficiency Electron-Emission in Pt/SiOx/Si/Al Structure,” Jpn. J. Appl. Phys. vol. 36, Part 2, No. 7B, pages L939-L941 (1997)

[Non-patent Document 3] S. Okamoto, “Electron emission from electroluminescent thin film—thin film cold cathode —” (in Japanese), OYO BUTURI, vol. 63, No. 6, pages 592-595 (1994)

[Non-patent Document 4] N. Koshida, “Light emission from porous silicon . . . Beyond the indirect/direct transition regime . . . ,” (in Japanese), OYO BUTURI, vol. 66, No. 5, pages 437-443(1997)

### SUMMARY OF THE INVENTION

When the image field of the display is enlarged, the scanning line length and data line length also become longer, and therefore it the wiring resistance (the interconnection resistance) must be reduced. With the larger screens that have appeared in recent years, the nominal diagonal size exceeds 20 inches, and may even be as much as 50 inches, 60 inches or more. Due to this enlargement, the distance from the power supply side to the free end is longer, and the resistance inevitably increases according to the increase in distance.

To deal with this increase of resistance, it has been proposed to provide scanning line drive circuits (scanning drivers) on the left and right sides so as to drive both ends, or to split the data lines into upper and lower, and install upper and lower data line drive circuits (data drivers) for the high-speed drive of data lines required in a high resolution display. However, in this case, the number of drivers is doubled, and costs increase. Moreover, if the data lines are split in the center part of the screen, a new problem arises in that there is undesirable discharge due to the electric potential difference in the split part.

Since an MIM emitter is a capacity drive, for a high resolution display, the data lines must have a lower resistance. The emitter includes a tunneling insulator film formed on a lower electrode, and an ultrathin upper electrode formed on this tunneling insulator film. The tunneling insulator film has a surface contour which follows the surface contour of the lower electrode, and the upper electrode is dependent on the surface contour of the tunneling insulator film. If the lower electrode becomes thicker due to sputtering of aluminum on multiple occasions, the process load increases, and since the surface becomes rougher it cannot be used for a data line.

It is therefore an object of the present invention to provide an image display device having data lines with a planarized surface which can form thin film emitters, and which have significantly lowered wiring resistance (interconnection resistance).

To attain the aforesaid object, according to the present invention, there are provided data lines formed by a thick film coated and embedded by screen printing, slit printing or the like in grooves formed by sandblasting in a first insulating substrate of a back panel. Part of the lower electrode of the emitter is connected to the data lines using evaporation method (also known as vapor-deposition method) like sputtering method or chemical vapor deposition for formation thereof, and is directly formed on the first insulating substrate having a planarized surface (principal surface).

Alternatively, according to the invention, the data lines have a double layer structure including a lower layer wiring film (a lower layer interconnection film), which is a thin film formed by evaporation method (IOW. deposition method e.g. chemical vapor deposition) such as by sputtering on the first insulating substrate of the back panel, and an upper layer wiring film (an upper layer interconnection film), which is a thick film formed by a printing technique on the lower layer wiring film. The lower electrode of the emitter is formed directly on the first insulating substrate having a planarized surface (principal surface) by chemical vapor deposition. This lower electrode and data line are connected by disposing an extension from the lower layer wiring film which extends towards the emitter side, in part of the lower layer of the lower electrode.

Alternatively, according to the invention, the data lines are formed by a thick wiring (interconnection) film formed by screen printing or slit printing on the first insulating substrate of the back panel. The lower electrode of the emitter is formed directly on the first insulating substrate having a planarized surface (principal surface) by evaporation method like chemical vapor deposition. This lower electrode and data line are connected by providing a thin film contact electrode, wherein part of the lower layer of the wiring film in the emitter-forming parts extends towards the emitter side, in part of the lower layer of the lower electrode.

According to the invention, the scanning lines can also have a double layer structure at least in the display region including a thick film lower layer electrode formed by an identical printing method, and an upper layer electrode formed by sputtering of aluminum or an aluminium alloy (Al—Nd or the like).

A typical configuration according to the invention is as follows.

(1) The image display device of the invention includes:

a back panel having plural scanning lines and plural data lines on a planarized principal surface of a first insulating substrate, and plural emitters (i.e. electron emitters) arranged in a matrix in the vicinity of the intersections between the scanning lines and the data lines;

a front panel having phosphors respectively corresponding to the emitters on the planarized principal surface of a second insulating substrate, and an anode which accelerates an electron flux (an electron beam) emitted from the emitters so as to collide with the phosphors;

a sealing frame interposed between the back panel and the circumference of the front panel so as to form a vacuum enclosure together with the back panel and the front panel; and

a spacer disposed between the back panel and the front panel which maintains the distance between the two panels at a predetermined value.

According to the present invention, plural grooves extend in one direction and are juxtaposed (arranged side-by-side) in another direction intersecting perpendicularly with this direction on the principal surface of the first insulating substrate forming the back panel,

each of the data lines includes a lower layer electrode film filled in the grooves by printing method, and an upper layer electrode film covering the lower layer electrode film and evaporated (e.g. vapor-deposited by chemical vapor deposition method) up to the planarized principal surface facing the grooves of the first insulating substrate, and

emitters are formed on the planarized principal surface facing the grooves of the first insulating substrate of the upper layer electrode film.

According to the invention, the lower layer electrode film may be a thick film formed by screen printing or slit printing of a silver paste (abbreviated as “Ag paste”), and the upper layer electrode film may be a thin film of aluminum or aluminum alloy formed by evaporation method (e.g. chemical vapor deposition).

According to the invention, the emitters may be thin film emitters each having an aluminum or aluminum alloy thin film as a lower electrode thereof, an anodized film formed on the surface of the aluminum or aluminum alloy thin film as an insulating film thereof, and a noble metal thin film formed above the insulating film of the anodized film as an upper electrode thereof.

Alternatively, according to the invention, each of the data lines is configured with a double layer film including a lower layer wiring film (a lower layer interconnection film) of a conductive thin film (an electrically conducting thin film) having an extension part extended into an area where one of the electron emitters is formed (the area also described as “the emitter-forming portions” hereinafter), and an upper layer wiring film (an upper layer interconnection film) formed by a printing method on the lower layer wiring film other than the extension part of the lower layer wiring film. The emitter may be a lower electrode which is a thin film electrode formed directly on the surface of the first insulating substrate in contact with the lower wiring film.

According to the invention, the aforesaid lower layer wiring film may be a thin film of conductive materials (electrically conducting materials) which does not lead to insulation defects due to oxidation, such as platinum, gold or iridium, and the aforesaid upper layer electrode film may be a thick film formed by screen printing of silver paste.

According to the invention, the emitters are configured with thin film electron emitters each having an aluminum or aluminum alloy a part of which is formed to be superimposed on a part of the lower layer wiring film as a lower electrode thereof, an anodized film formed on the surface of the aluminum or aluminum alloy as an insulating film thereof, and a noble metal thin film formed above the insulating film of the anodized film as an upper electrode thereof, wherein the lower electrode and the upper electrode are separated from each other by this insulating film.

Alternatively, according to the invention, the data lines may be configured with a wiring film (an interconnection film) formed by screen printing or slit printing, and include a thin film contact electrode which extends into the emitter-forming parts. The emitters may be formed above the lower electrode, wherein the thin film electrode formed directly on the surface of the first insulating substrate in contact with the thin film contact electrode as the lower electrode thereof.

According to the invention, the aforesaid thin film contact electrode may use a thin film of an a conductive material which does not lead to insulation defects due to oxidation, e.g. platinum, gold or iridium, and the wiring film forming the aforesaid data lines may be a thick film formed by printing (e.g. screen printing or slit printing) of silver paste.

According to the invention, the emitter may be configured with a thin film emitter having a thin film of aluminum or aluminum alloy partly superimposed on the lower layer electrode film as a lower electrode thereof, an anodized film formed on the surface of the aluminum or aluminum alloy thin film as an insulating film thereof, and a noble metal thin film formed above the insulating film of the anodized film as an upper electrode thereof.

The object of the invention can also be attained by a different aspect from the above technique. In another aspect of the invention, the data line also serving for the lower electrode of the emitter formed on the first insulating substrate of the back panel has a double layer structure. The lower electrode of this double layer structure is a coating film, i.e., a thick film which is preferably formed of silver paste (Ag paste), and its sufficient planarity for forming the thin film emitter thereby is secured by polishing the surface thereof. Therefore, the double layer structure is configured with two types of conductive materials different from each other and different in film thickness thereof. The surface roughness Rms which is an indicator of planarity is preferably less than 5 nm. The polished coating film is covered by sputtering of aluminum or aluminum alloy (e.g., Al—Nd) to form the upper layer electrode.

Alternatively, according to this technique, the data line also serving for the lower electrode of the emitter formed on the first insulating substrate of the back panel has a double layer structure configured with a coating film preferably formed of silver paste as a lower layer electrode thereof and an upper layer electrode thereof formed to cover the lower layer electrode by sputtering of aluminum or an aluminum alloy (e.g., Al—Nd) excepting in the emitter-forming position (an area where the emitter is not formed) at least in the display region. In the emitter-forming position (an area where the emitter is formed), the upper layer electrode is sputtered directly on the planarized surface of the first insulating substrate. In this case, there is no necessity in principle to perform surface polishing of the coating film which was formed in parts excepting the emitter-forming position.

The scanning line may also have the same double layer structure as described above at least in the display region to have the coating film as the lower layer electrode thereof and the upper layer electrode thereof formed by the sputtering of the aluminum or an aluminum alloy (e.g., Al—Nd).

In a typical configuration which reflects another aspect of the invention

(1) The image display device of the invention includes:

a back panel having plural emitters arranged in a matrix in the display region of the planarized principal surface of a first insulating substrate;

a front panel having phosphors respectively corresponding to the emitters on the planarized principal surface of a second insulating substrate, and an anode which accelerates an electron flux (electronbeam) emitted from the emitters so that it collides with the phosphors;

a sealing frame interposed between the back panel and the circumference of the front panel so as to form a vacuum enclosure together with the back panel and the front panel; and

a spacer disposed between the back panel and the front panel which maintains the distance between the two panels at a predetermined value.

In the first insulating substrate forming the back panel, a plurality of scanning lines are extended in a first direction and juxtaposed (arranged side-by side) in a second direction transverse to (e.g. perpendicular to) the first direction, a plurality of data lines are extended in the second direction and juxtaposed in the first direction so as to intersect with the scanning signal lines, and emitters are provided at each intersection between the scanning signal lines and data lines. The data lines are formed of two types of conductive materials (electrically conducting materials) different from each other and also different in film thickness thereof.

The two types of electrically conducting material of different film thickness may have a double layered-structure over the whole region including the emitter-forming portions (areas where the electron emitters are formed), at least in the display region.

One film of the double layered-structure in contact with the first insulating substrate is the aforementioned thick coating film, and another film of the double layered-structure is the aforementioned thin evaporated film (e.g. the thin chemical vapor deposition film) covering the thick coating film.

The data lines formed of the two types of conductive materials (electrically conducting materials) also different in film thickness thereof may be configured with a single layered-structure in the emitter-forming portions (areas where the electron emitters are formed) and configured with a double layered-structure in other portion(s) than the emitter-forming portions, at least in the display region.

One film of the double layered-structure in contact with the first insulating substrate in the portion(s) other than the emitter-forming portions is the aforementioned thick coating film, another film of the double layered-structure is the aforementioned thin evaporated film (e.g. the thin chemical vapor deposition film) in contact with the first insulating substrate in the emitter-forming portions, and the another film of the double layered-structure is formed so as to cover the coating film except in the emitter-forming portions.

According to the invention, the coating film surface is a planarized surface, and the aforementioned evaporated film has a planarized surface patterned after (e.g. formed similarly to) the coating film surface. The evaporated film in contact with the first insulating substrate in the emitter-forming portions has a planarized surface patterned after the surface of the first insulating substrate.

According to the invention, the emitters may include a lower electrode formed by deposition of one of the two types of conductive materials forming the data line, an insulating film laminated on the lower electrode and thinned in a part thereof which is an electron emission region emitting electrons so as to form an electron emitter opening, and an upper electrode in contact with the scanning line and covering the insulating film including the thinned part.

In the image display device of the invention, the spacer may be arranged on a scanning line and also extend along the scanning line. For example, the spacer is fixed to the principal surface of the back panel or front panel, and arranged to stand on a scanning line of this surface (or in a part on which this projects). Further, in the image display device of the invention, the scanning lines may also have an identical double layer structure, including a coating film and sputter film, to the data lines. In the scanning lines, it is not particularly necessary to polish and planarize the surface of the coating film in the lower layer.

The invention is not to be construed as being limited in any way by the aforesaid configurations and examples described later, and it will be understood that various modifications are possible within the scope and spirit of the appended claims.

By providing emitters using data lines having the structure of the invention, the resistance of the data lines can be largely reduced, high resolution can be achieved even with a one-sided power supply, and costs can be lowered by reducing the number of drivers.

### BRIEF DESCRIPTION OF THE DRAWINGS

FIGS. 1A-1D are diagrams describing the structure of a back panel in a first embodiment of the image display device according to the invention. FIG. 1A is a plan view, FIG. 1B is a cross-sectional view along a line A-A′ of FIG. 1A, FIG. 1C is a cross-sectional view along a line B-B′ of FIG. 1A, FIG. 1D is a cross-sectional view along a line C-C′ of FIG. 1A, respectively.

FIGS. 2A-2C are diagrams describing a process for manufacturing the back panel of the image display device in the first embodiment according to the invention. FIG. 2A is a plan view of the first insulating substrate SUB1 (principal surface) which is the base member of the back panel, FIG. 2B is a cross-sectional view along a line A-A′ of FIG. 2A, and FIG. 2C is a cross-sectional view along a line B-B′ of FIG. 2A, respectively.

FIGS. 3A-3C are diagrams respectively following FIGS. 2A-2C, describing a process for manufacturing the back panel of the image display device in the first embodiment according to the invention.

FIGS. 4A-4C are diagrams respectively following FIGS. 3A-3C, describing a process for manufacturing the back panel of the image display device in the first embodiment according to the invention.

FIGS. 5A-5C are diagrams respectively following FIGS. 4A-4C, describing a process for manufacturing the back panel of the image display device in the first embodiment according to the invention.

FIGS. 6A-6C are diagrams respectively following FIGS. 5A-5C, describing a process for manufacturing the back panel of the image display device in the first embodiment according to the invention.

FIGS. 7A-7C are diagrams respectively following FIGS. 6A-6C, describing a process for manufacturing the back panel of the image display device in the first embodiment according to the invention.

FIGS. 8A-8C are diagrams respectively following FIGS. 7A-7C, describing a process for manufacturing the back panel of the image display device in the first embodiment according to the invention.

FIGS. 9A-9C are diagrams respectively following FIGS. 8A-8C, describing a process for manufacturing the back panel of the image display device in the first embodiment according to the invention.

FIGS. 10A-10C are diagrams respectively following FIGS. 9A-9C, describing a process for manufacturing the back panel of the image display device in the first embodiment according to the invention.

FIGS. 11A-11C are diagrams respectively following FIGS. 10A-10C, describing a process for manufacturing the back panel of the image display device in the first embodiment according to the invention.

FIGS. 12A-12C are diagrams respectively following FIGS. 11A-11C, describing a process for manufacturing the back panel of the image display device in the first embodiment according to the invention.

FIGS. 13A-13C are diagrams respectively following FIGS. 12A-12C, describing a process for manufacturing the back panel of the image display device in the first embodiment according to the invention.

FIGS. 14A-14C are diagrams respectively following FIGS. 13A-13C, describing a process for manufacturing the back panel of the image display device in the first embodiment according to the invention. FIG. 14A is a plan view of the first insulating substrate SUB1 (principal surface) which is the base member of the back panel, FIG. 14B is a cross-sectional view along a line A-A′ of FIG. 14A, and FIG. 14C is a cross-sectional view along a line C-C′ of FIG. 14A, respectively.

FIGS. 15A-15C are diagrams respectively following FIGS. 14A-14C, describing a process for manufacturing the back panel of the image display device in the first embodiment according to the invention.

FIGS. 16A-16C are diagrams respectively following FIGS. 15A-15C, describing a process for manufacturing the back panel of the image display device in the first embodiment according to the invention.

FIGS. 17A-17C are diagrams respectively following FIGS. 16A-16C, describing a process for manufacturing the back panel of the image display device in the first embodiment according to the invention.

FIGS. 18A-18C are diagrams respectively following FIGS. 17A-17C, describing a process for manufacturing the back panel of the image display device in the first embodiment according to the invention.

FIGS. 19A-19C are diagrams respectively following FIGS. 18A-18C, describing a process for manufacturing the back panel of the image display device in the first embodiment according to the invention.

FIGS. 20A-20C are diagrams respectively following FIGS. 19A-19C, describing a process for manufacturing the back panel of the image display device in the first embodiment according to the invention.

FIGS. 21A-21C are diagrams respectively following FIGS. 20A-20C, describing a process for manufacturing the back panel of the image display device in the first embodiment according to the invention.

FIGS. 22A-22C are diagrams respectively following FIGS. 21A-21C, describing a process for manufacturing the back panel of the image display device in the first embodiment according to the invention.

FIGS. 23A-23C are diagrams respectively following FIGS. 22A-22C, describing a process for manufacturing the back panel of the image display device in the first embodiment according to the invention.

FIGS. 24A-24C are diagrams respectively following FIGS. 23A-23C, describing a process for manufacturing the back panel of the image display device in the first embodiment according to the invention.

FIGS. 25A-25C are diagrams showing the structure of a back panel in a second embodiment of the image display device according to the invention. FIG. 25A is a plan view of the principal surface of the first insulating substrate SUB1 (back panel), FIG. 25B is a cross-sectional view along a line A-A′ of FIG. 25A, and FIG. 25C is a cross-sectional view along a line B-B′ of FIG. 25A, respectively.

FIGS. 26A-26C are diagrams showing the structure of a back panel in a third embodiment of the image display device according to the invention. FIG. 26A is a plan view of the principal surface of the first insulating substrate SUB1 (back panel), FIG. 26B is a cross-sectional view along a line A-A′ of FIG. 26A, and FIG. 26C is a cross-sectional view along a line B-B′ of FIG. 26A, respectively.

FIG. 27 is a cross-sectional view following FIG. 47 of the cross-sectional surface of an emitter in a fourth embodiment of the image display device according to the invention.

FIG. 28 is a cross-sectional view following FIG. 48 of the cross-sectional surface of an emitter in the fourth embodiment of the image display device according to the invention.

FIG. 29 is a diagram showing the manufacturing process of the fourth embodiment of the image display device according to the invention.

FIG. 30 is a diagram showing a resistance variation of a data signal line relative to film thickness of a lower layer electrode having a double layer structure.

FIG. 31 is a cross-sectional view of a back panel, identical to that of FIG. 27, of an emitter part showing a fifth embodiment of the image display device according to the invention.

FIG. 32 is a cross-sectional view of a back panel corresponding to FIG. 2, of an emitter part showing the fifth embodiment of the image display device according to the invention.

FIG. 33 is a diagram showing the manufacturing process of the fifth embodiment of the image display device according to the invention.

FIGS. 34A-34B are diagrams showing a first-example of a data line in the fifth embodiment of the image display device according to the invention. FIG. 34A shows the planarized shape of a lower layer electrode dA in the vicinity of an electron emission region EMT (pixel), and FIG. 34B shows the planarized shape of an upper layer electrode dB, respectively.

FIGS. 35A-35B are diagrams showing a second example of a data line in the fifth embodiment of the image display device according to the invention. FIG. 35A shows the planarized shape of the lower layer electrode dA in the vicinity of an electron emission region EMT (pixel), and FIG. 35B shows the planarized shape of the upper layer electrode dB, respectively.

FIGS. 36A-36B are diagrams showing a third example of a data line in the fifth embodiment of the image display device according to the invention. FIG. 36A shows the planarized shape of a lower layer electrode dA in the vicinity of an electron emission region EMT (pixel), and FIG. 36B shows the planarized shape of an upper layer electrode dB, respectively.

FIG. 37 is a schematic view of a display panel describing the effect according to the invention.

FIG. 38 is a schematic view of another display panel describing the effect according to the invention.

FIG. 39 is a schematic view of a display panel of the prior art describing the effect according to the invention.

FIG. 40 is a partial cut-away perspective view showing one example of the overall structure of the image display device according to the invention in more detail.

FIG. 41 is a cross-sectional view of the image display device as seen along a line A-A′ in FIG. 40.

FIG. 42 is a diagram showing an example of an equivalent circuit of the image display device according to the invention.

FIG. 43 is a diagram showing the display principle of one pixel of a display panel in an image display device using an MIM emitter.

FIG. 44 is a diagram showing the voltage-current characteristics of the diode emitter shown in FIG. 43.

FIG. 45 is a cut-away perspective view showing an example of the overall structure of a panel in a full colour image display device.

FIG. 46 is a plan view of an emitter in a back panel PNL1 shown in FIG. 45.

FIG. 47 is a cross-sectional view along a line A-A′ in FIG. 46.

FIG. 48 is a cross-sectional view along a line B-B′ in FIG. 46.

### DETAILED DESCRIPTION OF THE INVENTION

This invention will now be described in more detail referring to drawings of the embodiments.

### Embodiment 1

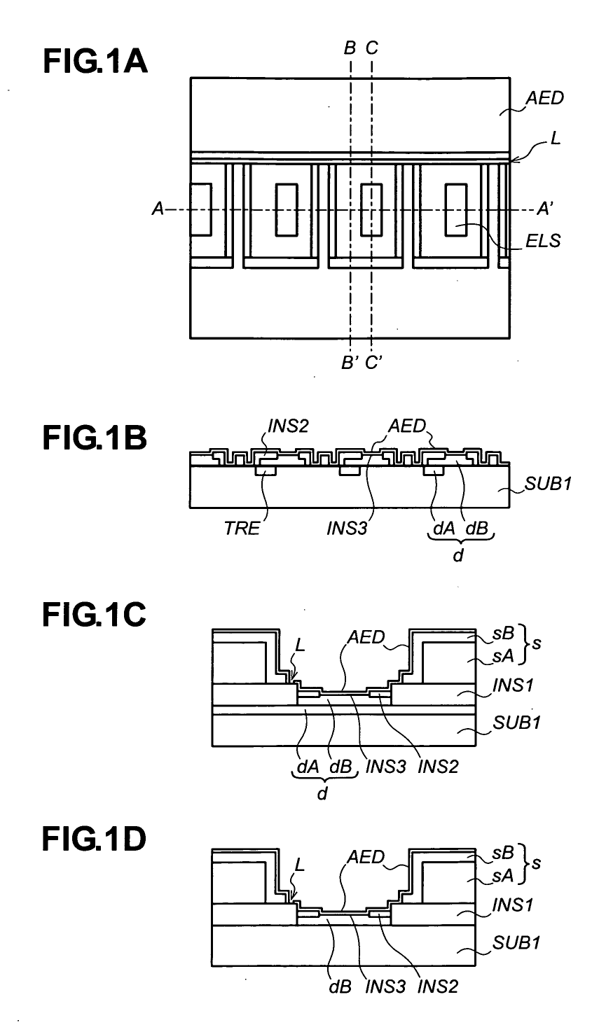

FIGS. 1A-1D are drawings showing the structure of a back panel in a first embodiment of the image display device according to the invention. FIG. 1A is a plan view, FIG. 1B is a cross-sectional view along a line A-A′ of FIG. 1A, FIG. 1C is a cross-sectional view along a line B-B′ of FIG. 1A, and FIG. 1D is a cross-sectional view along a line C-C′ of FIG. 1A. This back panel includes a first insulating substrate SUB1 (preferably glass), and a groove TRE is formed by sandblasting on the planarized principal surface (surface) thereof.

This groove TRE extends in one direction (up/down direction of FIG. 1A) on the principal surface of the first insulating substrate SUB1, plural grooves being juxtaposed (arranged side-by-side) in another direction which intersects (is perpendicular to) this direction. The groove TRE is printed with silver paste (Ag paste) by screen printing or slit printing to coat the groove TRE, this silver paste which fills the groove preferably forming a lower layer electrode film dA. An upper layer electrode film dB superimposed on at least part of the lower layer electrode film dA is formed from the upper surface of this lower layer electrode film dA (groove TRE) to a region of the planarized principal surface of the first insulating substrate SUB1 adjacent to the groove TRE of an aluminum (Al) film or aluminum alloy (aluminum-neodymium alloy: Al—Nd) film evaporated (deposited) by sputtering method or the like. Hence, the data line d is formed as a laminated film of two layers, i.e., the lower layer electrode film dA and the upper layer electrode film dB. In the principal surface of the first insulating substrate SUB1, the “region” adjacent to the groove TRE, wherein the lower layer electrode dA is formed which is electrically connected thereto, extends to another groove TRE adjacent to this groove TRE, but the upper layer electrode film dB is electrically isolated from the other lower electrode film dA formed in the other groove TRE. Therefore, if this “region” is defined as extending from this groove TRE to the other groove TRE, the extension of the upper layer electrode film dB terminates within this “region”. In the following description, the aluminum (Al) film or aluminum alloy (aluminum-neodymium alloy: Al—Nd) film is referred to simply as the aluminum film.

A second insulating film INS2 is formed by anodization surrounding the region wherein the emitter ELS of the upper surface of the upper layer electrode film dB is formed, and a third insulating film INS3 is likewise formed as a tunnel film by anodization in the region wherein the emitter ELS is formed.

Scanning lines s insulated by the first insulating film INS1 are formed on both sides of the data line d. The scanning line s is a double layer laminated film including a lower layer electrode film sA, which is a thick film formed by screen printing or slit printing of Ag paste, and an upper layer electrode film sB which is an aluminum film.

A thin film AED of a noble metal such as platinum, gold, platina or the like which is the upper electrode of the emitter, is formed on the whole of the principal surface of this back panel (first insulating substrate SUB1). By cutting the part of this thin film AED shown by an arrow L with a laser, the forming regions of the emitter ELS are separated for each adjacent scanning line s.

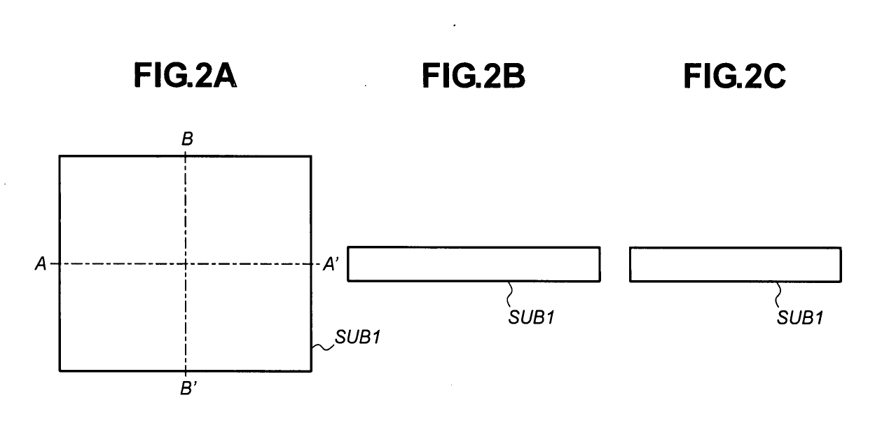

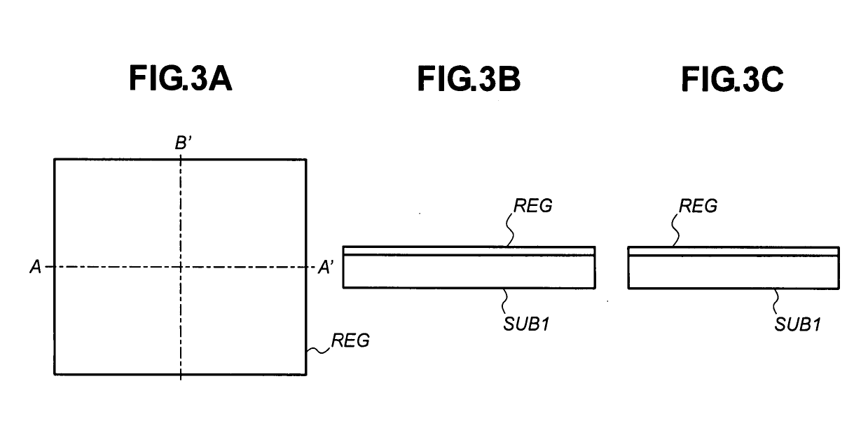

Next, the process of manufacturing the back panel in the image display device of the first embodiment will be described referring to FIG. 2A-FIG. 24C. The film structures shown in FIGS. 3A-24C are sequentially formed on the principal surface of the first insulating substrate SUB1 shown in FIGS. 2A-2C. The line A-A′ in FIGS. 2A-24C extends in the extension direction (or planned extension direction) of the scanning line s, the line B-B′ extends in the extension direction (or planned extension direction) of the data line d, respectively, and both pass over or are considered to pass over the groove TRE. The line C-C′ extends in the extension direction of the data line d, and is a line which passes over the emitter in a part not lying over the groove TRE.

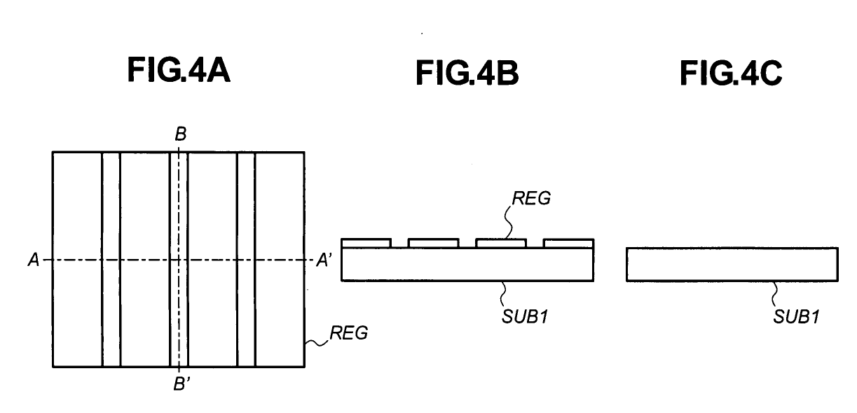

First, the first insulating substrate SUB1 which is preferably a glass plate, is prepared. If required, it is polished flat so that the principal surface of this first insulating substrate SUB1 is a predetermined planarized surface, and is cleaned (FIGS. 2A-2C). A photosensitive resist REG is then coated on this principal surface as a sandblasting protection film, and dried (FIGS. 3A-3C). The dried photosensitive resist REG is exposed, developed and dried in this order, and patterning is performed in order to form the groove TRE in the extension direction of the data line (FIGS. 4A-4C).

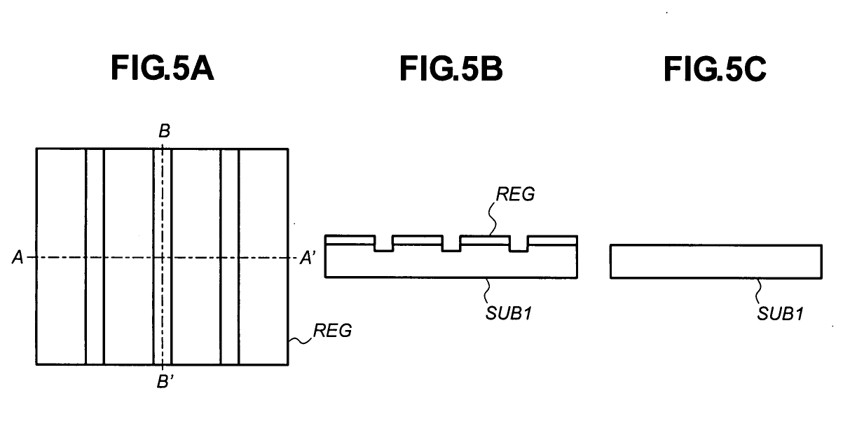

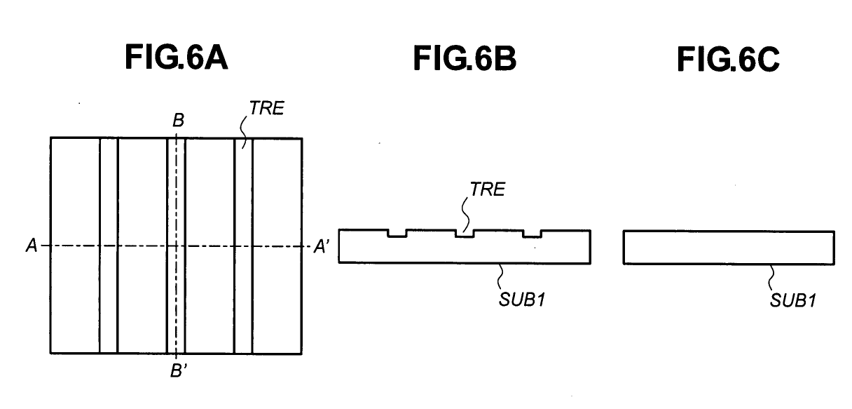

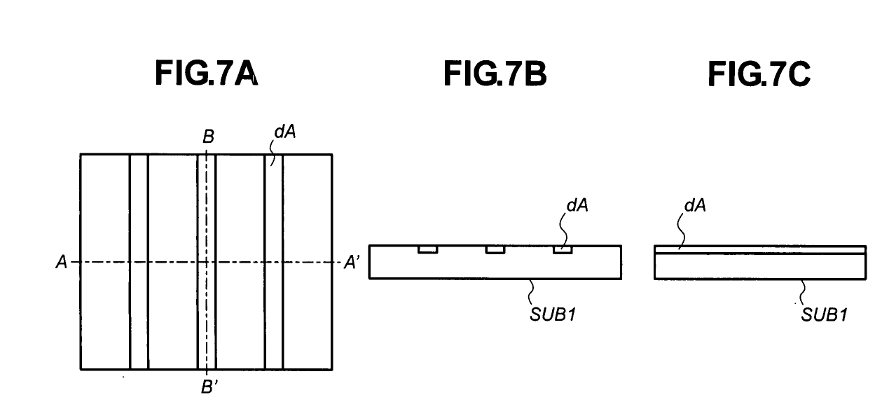

Sandblasting is then performed using the patterned photosensitive resist REG as a protection film to form the groove TRE in parts without the photosensitive resist REG (FIGS. 5A-5C). Following this, the resist REG which is the sandblasting protection film is removed from the first insulating substrate SUB1, the principal surface of the first insulating substrate SUB1 is cleaned, and dried (FIGS. 6A-6C). Silver paste is then embedded in the groove TRE by screen printing, drying/baking is performed, and the surface is polished to form the lower layer electrode film dA of the data line (FIGS. 7A-7C).

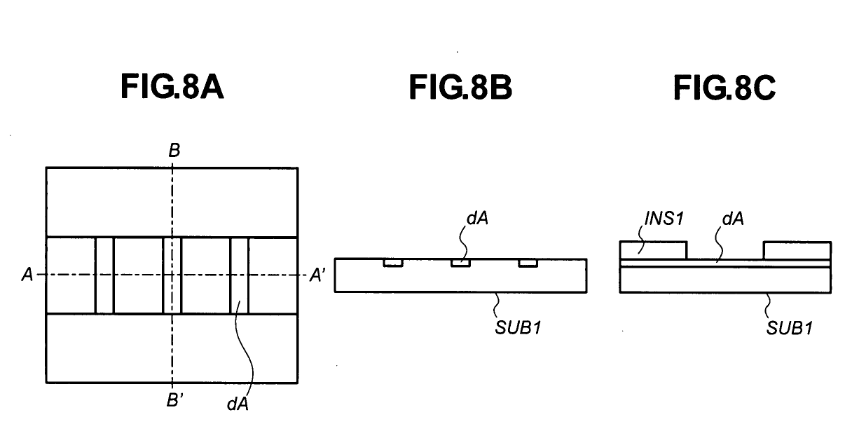

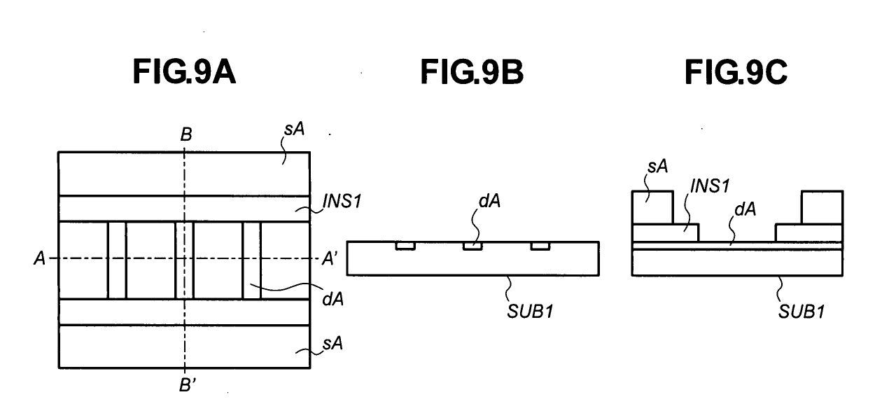

Next, low melting point glass is printed by screen printing, slit printing or the like in the scanning line-forming part which intersects the lower layer electrode film dA of the data line, and dried/baked to form the first insulating film INS1 (FIGS. 8A-8C) Silver paste is then coated by screen printing on the first insulating film INS1, and dried/baked to form the lower layer electrode film sA of the scanning line (FIGS. 9A-9C). At this time, part of the first insulating film INS1 on the emitter-forming region side is exposed so that the cross-sectional surface is stepped.

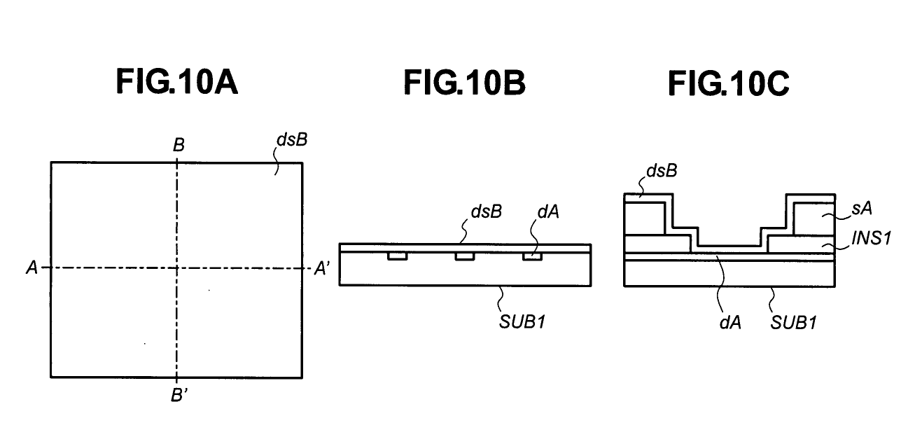

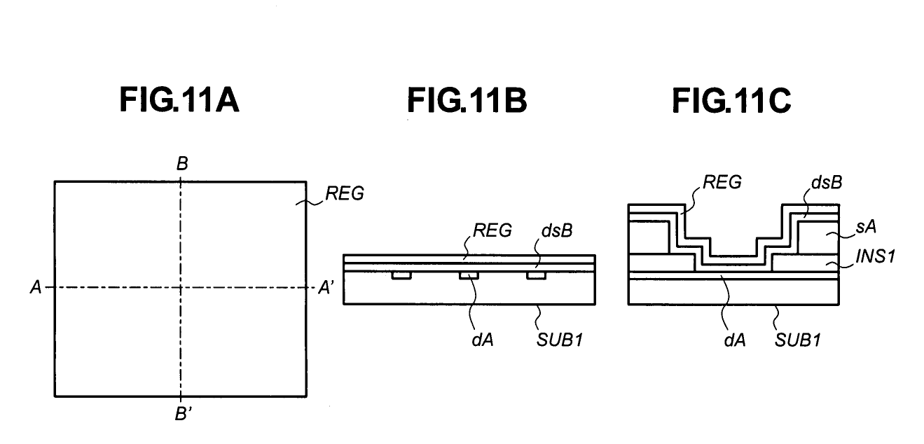

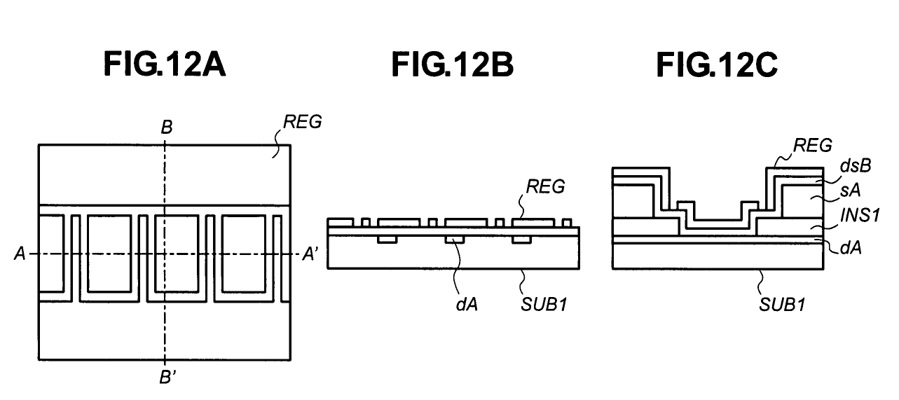

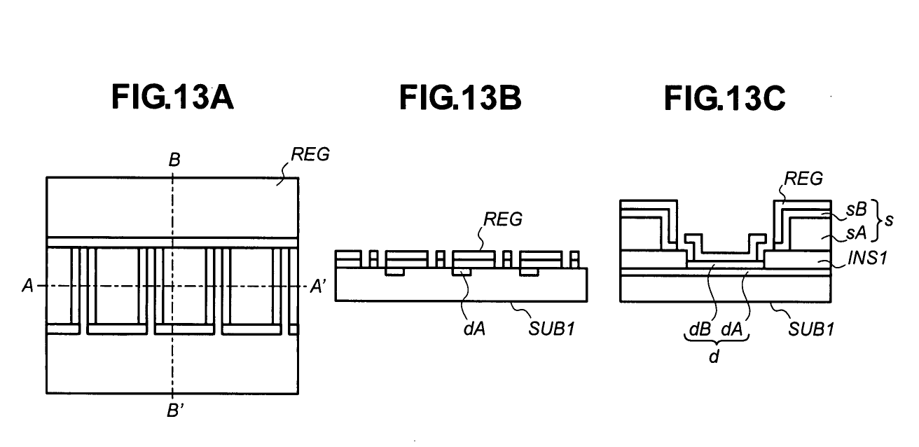

An aluminum film dsB which is the upper layer electrode film of the data line and the upper layer electrode film of the scanning line is formed by evaporation method e.g. vapor-deposition method, sputtering method, or the like so as to cover the lower layer electrode film dA of the data line, the lower layer electrode film sA of the scanning line and the exposed part of the first insulating film INS1 (FIGS. 10A-10C) The whole of the aluminum film dsB is then coated by the photosensitive resist REG, and dried (FIGS. 11A-11C). This photosensitive resist REG is exposed, developed and dried in this order using a photo mask having a predetermined pattern, and the resist is removed at the boundary between the upper layer electrode film of the data line and the upper layer electrode film of the scanning line (FIGS. 12A-12C). This is etched so that the aluminum film dsB is split into the upper layer electrode film dB of the data line and upper layer electrode film sb of the scanning line (FIGS. 13A-13C).

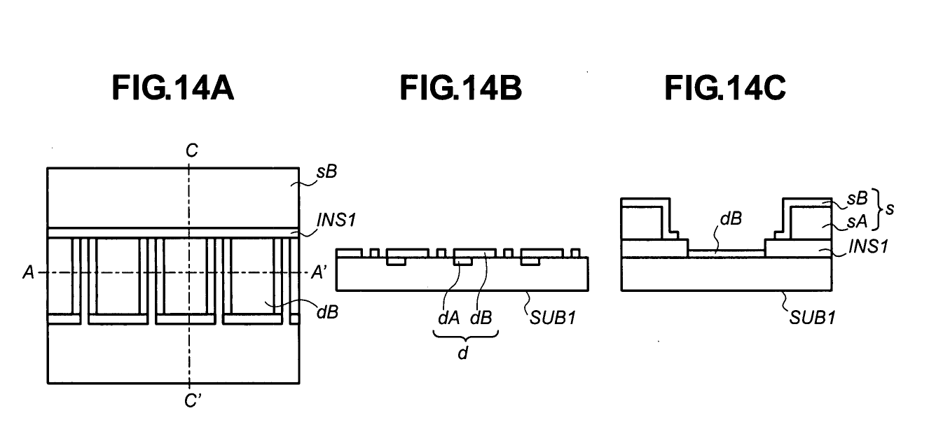

The data line d has a double layer structure including the lower layer electrode film dA and upper layer electrode film dB. The emitter-forming region of the upper layer electrode film dB lies directly on the surface of the planarized first insulating film INS1. The scanning line s also has a double layer structure including the lower layer electrode film sA and upper layer electrode film sB. Following this, the resist is removed, and cleaning/drying are performed (FIGS. 14A-14C).

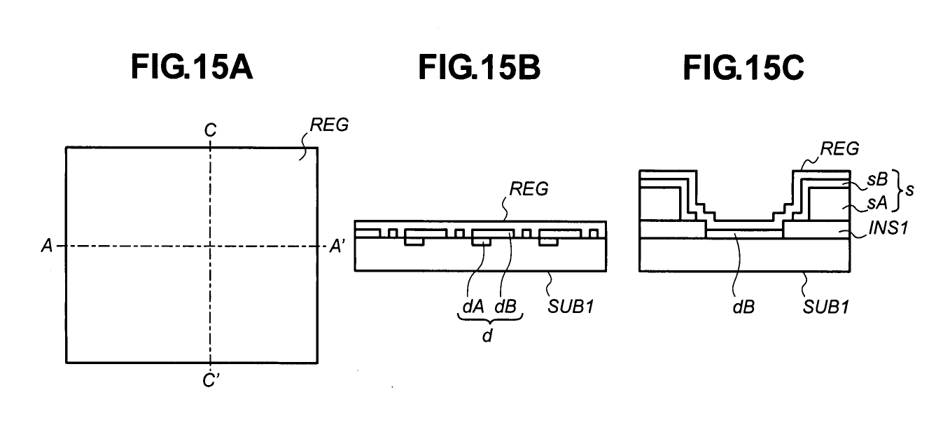

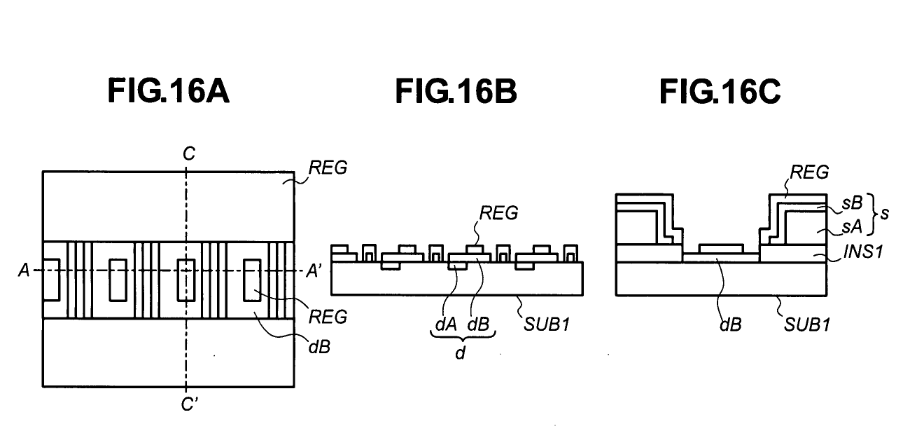

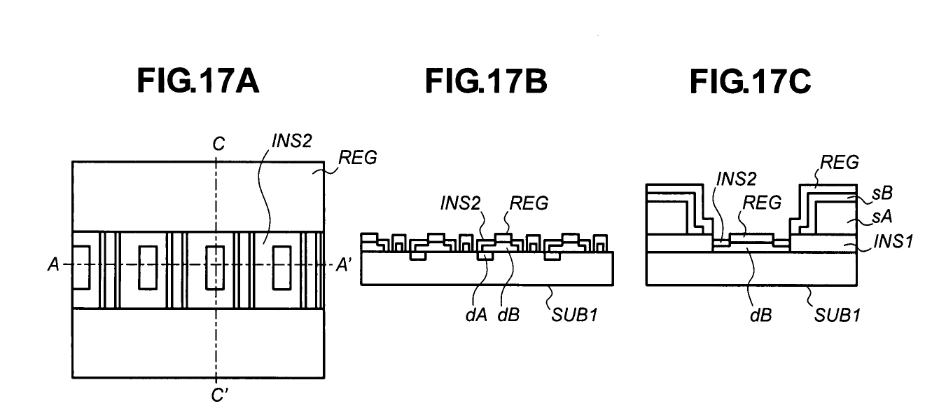

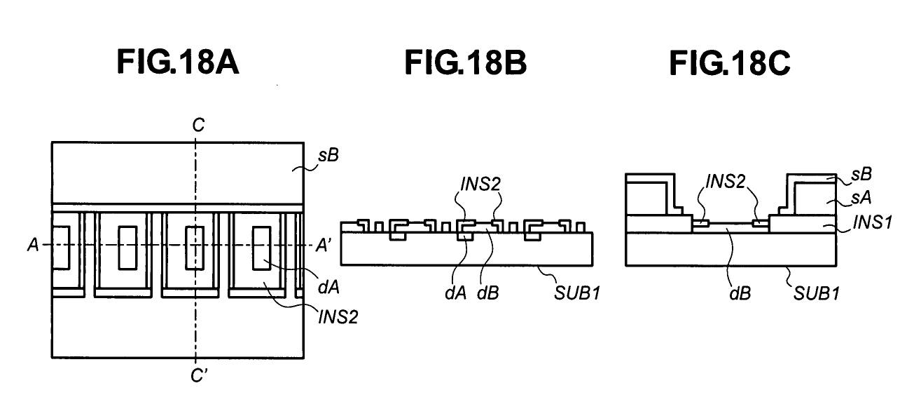

Next, the whole surface of the first insulating film INS1 is coated by the photosensitive resist REG, and dried (FIGS. 15A-15C). The photosensitive resist REG is exposed using a photo mask having a predetermined pattern, developed and dried in that order, and the resist REG is removed in the part of the upper layer electrode film dB (aluminum film) of the data line d excepting the emitter-forming region to form an opening pattern for a second insulating film INS2 (field insulating film) (FIGS. 16A-16C). In this state, the first insulating substrate SUB1 is dipped in an anodizing bath, and the second insulating film INS2 is formed on the surface by anodization of the upper layer electrode film dB (FIGS. 17A-17C). Following this, the resist REG is removed from the first insulating substrate SUB1, and the principal surface of the first insulating substrate SUB1 is cleaned/dried (FIGS. 18A-18C).

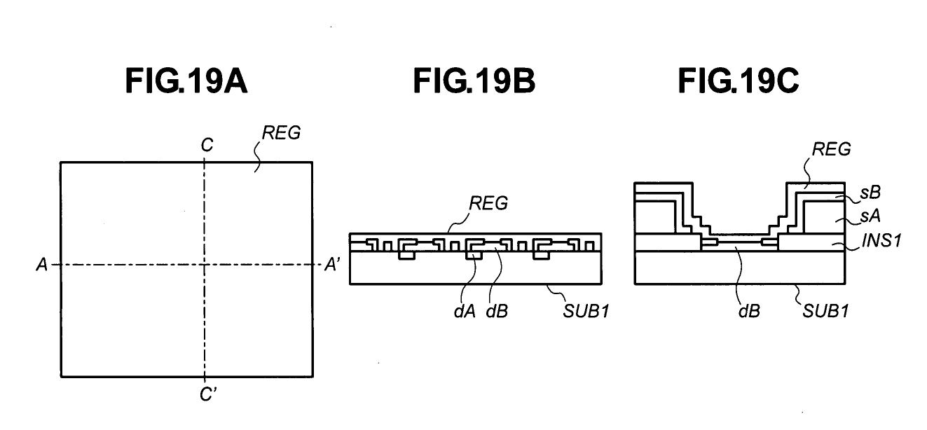

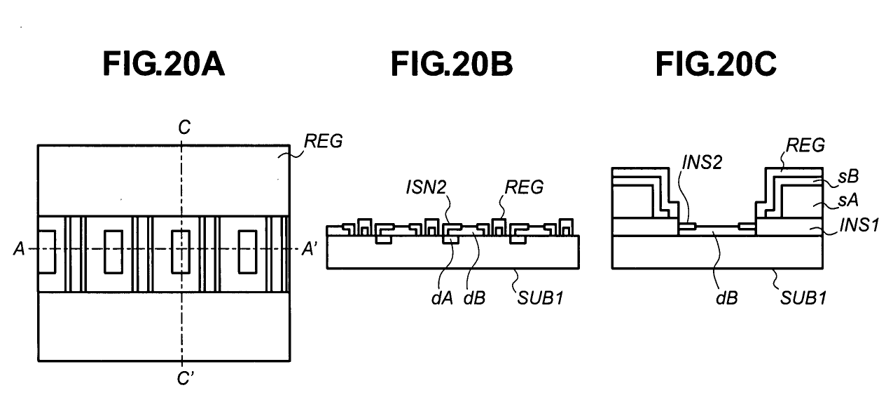

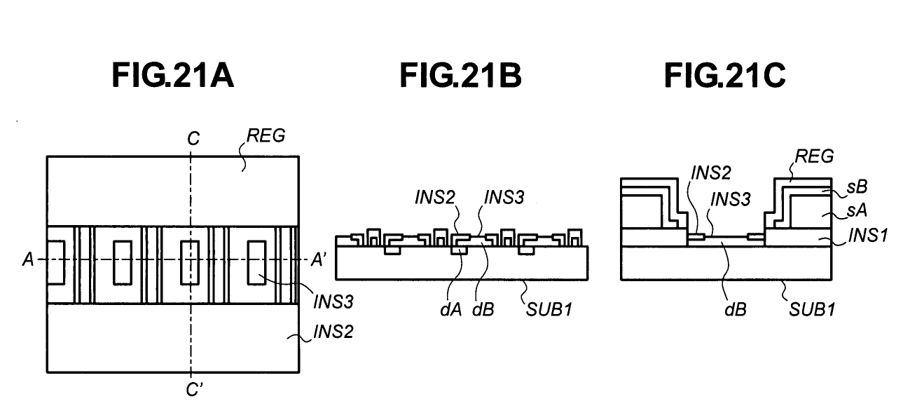

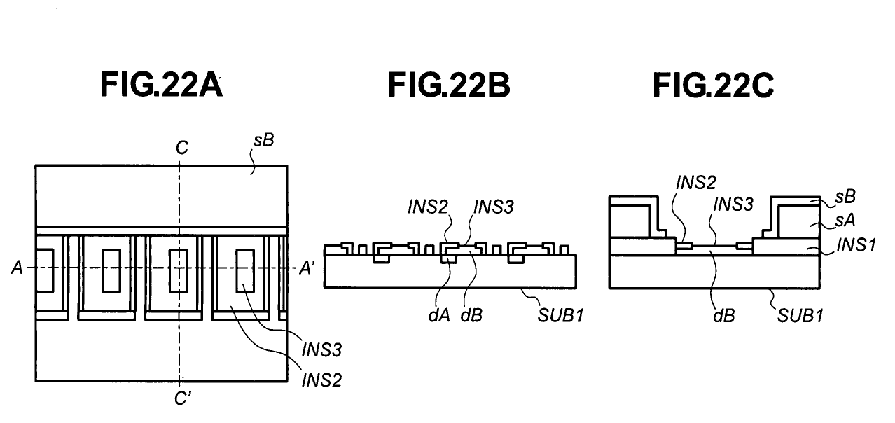

Next, the whole surface of the first insulating film INS1 is coated by the photosensitive resist REG, and dried (FIGS. 19A-19C). The photosensitive resist REG is exposed using a photo mask having a predetermined pattern, developed and dried in that order, and patterning is performed in order to form a third insulating film INS3 (tunnel film) (FIGS. 20A-20C). In this state, the first insulating substrate SUB1 is again dipped in an anodizing bath, and the third insulating film INS3 is formed on the surface (part to become the emitter) by anodization of the upper layer electrode film dB (FIGS. 21A-21C). Following this, the resist REG is removed from the first insulating substrate SUB1, and the principal surface of the first insulating substrate SUB1 is cleaned/dried (FIGS. 22A-22C).

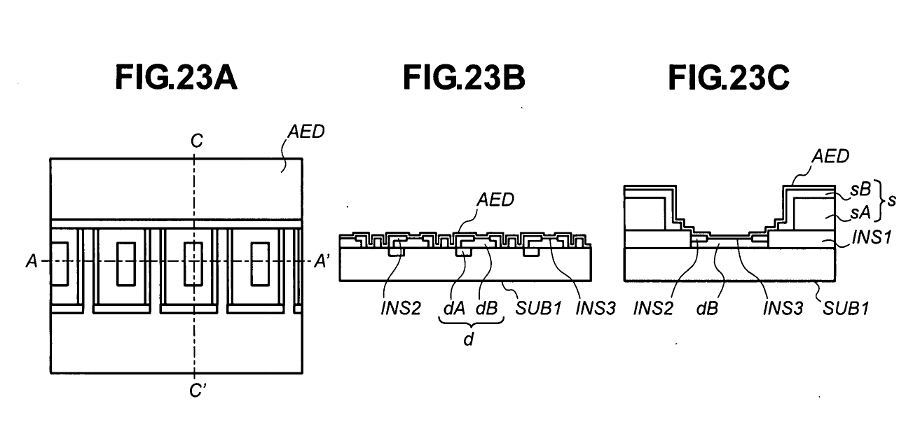

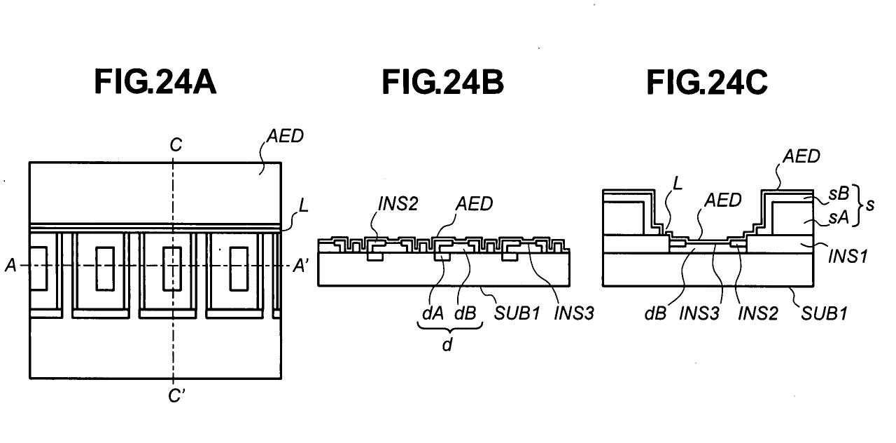

A metal film for forming the upper electrode AED of the emitter is then formed by, e.g., sputtering of iridium (Ir), platinum (Pt), gold (Au), or two or more thereof, on the whole surface of the first insulating film INS1 on which the third insulating film INS3 was formed (FIG. 23). The regions between adjacent scanning lines are then separated by a laser (FIGS. 24A-24C).

The above series of processes from FIGS. 2-24 completes the back panel shown in FIG. 1. The front panel is fixed to the back panel via the sealing frame, the back panel forming a one piece-structure together with the sealing frame and front panel. The display panel is then completed by placing the interior of the space enclosed by the front panel, back panel and sealing frame under a vacuum. The image display device is obtained by combining this display panel with drive circuits and other members.

According to this structure, since the data lines d have a double layer structure including a thick film obtained by printing Ag paste and an aluminum film, a lower resistance can be achieved. Further, since the lower layer electrode dA wherein the emitter ELS is formed directly by evaporation method on the planarized surface of the first insulating substrate SUB1, is the lower electrode, and its tunnel film is planarized, the upper electrode formed thereupon is also planarized and of good quality, so the emitter ELS obtained has a uniform electron emission.

### Embodiment 2

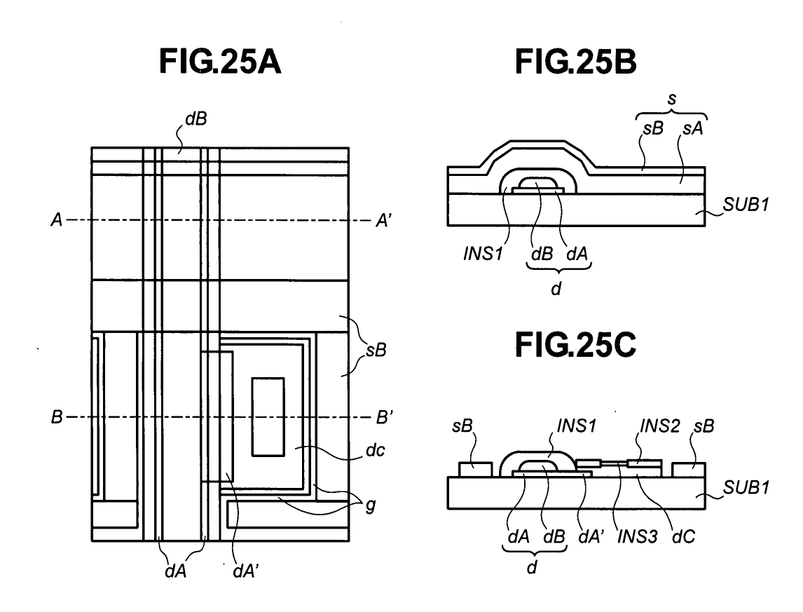

FIGS. 25A-25C are diagrams showing the back panel of a second embodiment of the image display device according to the invention. FIG. 25A is a plan view in the vicinity of one pixel, FIG. 25B is a cross-sectional view along a line A-A′ in FIG. 25A, and FIG. 25C is a cross-sectional view along a line B-B′ in FIG. 25. In Embodiment 1, the lower resistance data line d was obtained by coating and embedding silver paste in a groove on the principal surface of the first insulating substrate SUB1, but in the second embodiment, this groove is not formed in the first insulating substrate SUB1. Instead, a lower resistance data line d having a double layer structure is obtained by forming a film of a highly conducting metal on the principal surface, and then coating Ag paste on this highly conducting metal film. Also, a high quality tunnel film (third insulating film INS3) is formed by directly forming a lower electrode dC of the emitter on the principal surface of the first insulating substrate SUB1.

In the back panel of the second embodiment, the lower electrode film dA is formed along the data line on the principal surface of the first insulating substrate SUB1 which is preferably a glass plate. This lower electrode film dA is formed by sputtering a conductive material (an electrically conducting material) which does not lead to insulation defects due to oxidation, such as platinum (Pt), gold (Au) or iridium (Ir). As shown in FIG. 25C, this lower layer electrode film dA has an extension dA′ which extends on the emitter-forming region side. Ag paste is then coated on the lower layer electrode film dA to form the upper layer electrode film dB, and the data line d provided therefore has a double layer structure including the lower layer electrode film dA and upper layer electrode film dB.

The first insulating film INS1 which provides insulation from the scanning lines, is formed by coating the data line d including the lower layer electrode film dA and upper layer electrode film dB with low melting point glass. The lower layer electrode film sA of the scanning line is then formed by printing Ag paste in the scanning line part, and an aluminum film is formed by sputtering thereupon. As shown in FIG. 25A, by forming a gap g around the region in which the emitter is formed by photolithography, the aluminum film is split into the upper layer electrode film sB and lower electrode film dC of the scanning line. As shown in FIG. 25C, the aluminum film is laminated on the extension dA′ of the lower layer electrode film dA of the data line d, the lower layer electrode film dA of the data line d and lower electrode dC of the emitter being electrically connected together.

To suppress oxidation of the surface of the lower layer electrode film dA when the upper layer electrode film dB is formed, and lower the electrical resistance at the join interface between the lower layer electrode film dA and upper layer electrode film dB, the lower layer electrode film dA is formed of a metal material such as platinum, gold or iridiumas described above, but it may be formed also of an conductive material oxide such as ITO (indium-tin-oxide) or IZO (indium-zinc-oxide). Since the surface of the lower electrode film dA formed by the conductive (electrically conducting) oxide is not easily oxidized even if exposed to oxygen in the atmosphere when the upper layer electrode film dB is formed thereupon, the electrical resistance at the join interface between this and the upper layer electrode film dB can be suppressed low.

However, if the aforesaid lower electrode dC is formed of aluminum or aluminum alloy (anodized metal or alloy) on the surface of the lower layer electrode film dA of the conductive oxide, oxygen contained in the lower layer electrode film dA (conductive oxide) thermally diffuses into the lower electrode dC, and reacts with aluminum so that aluminum oxide may be formed in the vicinity of the join interface between the lower layer electrode film dA and lower electrode dC. Even if the metal used to anodize the lower electrode dC is tantalum (Ta), there is still a possibility that tantalum oxide will likewise be formed in the vicinity of the join interface between the lower layer electrode film dA and lower electrode dC. If this type of oxide is formed due to process conditions when the lower electrode dC is laminated on the lower layer electrode film dA, the electrical resistance between the lower layer electrode film dA and lower electrode dC may increase, and lead to conduction defects between the two.

In view of this phenomenon, when the lower layer electrode film dA is formed of a conductive oxide, it is recommended that the lower electrode dC has a laminar structure including a first layer of chromium (Cr) formed on the lower layer electrode film dA, and a second layer of aluminum or aluminum alloy (“anodized metal or alloy”) formed on the first layer, and that this is patterned. The chromium of the first layer may be replaced by another metal or alloy which is not easily oxidized and which can bond to the anodized metal or alloy with low resistance. If the second layer of the lower electrode dC formed in this way is the thin film dC shown in FIG. 25C, the first layer can be inserted at the join interface between the thin film dC and the lower layer electrode film dA, and the join interface between the thin film dC and first insulating substrate SUB1, respectively, and patterned. Also, by forming the lower electrode dC in this way, conduction defects between the lower layer electrode film dA and lower electrode dC can be avoided.

On the upper surface of the lower electrode dC of the emitter, the second insulating film INS2 (field insulating film) is formed by anodization surrounding the part to become the emitter, and the third insulating film INS3 (tunnel insulating film) is formed in the part to become the emitter, respectively. Also, although not shown, a metal film for forming the upper electrode AED of the emitter, is formed by sputtering iridium (Ir), platinum (Pt) or gold (Au), or two or more thereof, on the whole surface of the back panel substrate SUB1 to which these various film-forming treatments have been applied. Following this, as described for Embodiment 1 referring to FIGS. 24A-24C, the back panel is completed by separating adjacent scanning lines.

The display panel is completed by integrating the back panel and front panel in a one-piece structure via the sealing frame, and placing the space surrounded by them under a vacuum. The image display device is obtained by combining this display panel with various drive circuits and other members.

According to the second embodiment, a lower resistance is achieved since the data line d has a double layer structure including a thick film formed by printing Ag paste, and an aluminum film. Since the emitter ELS uses an aluminum film formed directly by evaporation method on the planarized surface of the first insulating substrate SUB1 as the lower electrode dC, the tunnel film (third insulating film INS3) formed on this lower electrode dC is planarized, and the upper electrode formed on this tunnel film is also a planarized, high quality film. Due to this, the emitter ELS can give a uniform electron emission.

### Embodiment 3

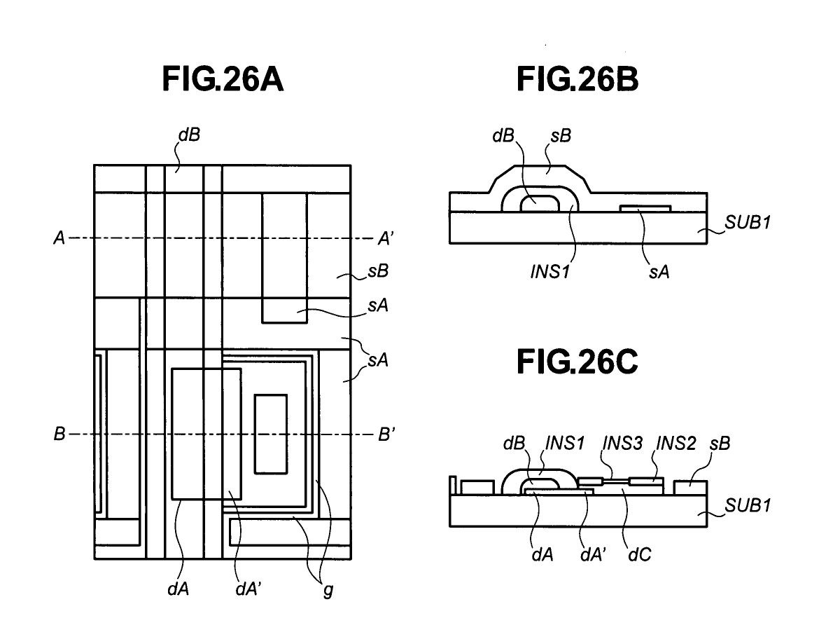

FIGS. 26A-26C are diagrams showing the structure of a back panel in a third embodiment of the image display device according to the invention. FIG. 26A is a plan view of one pixel formed on the principal surface of the first insulating substrate SUB1 and its vicinity, FIG. 26B is a cross-sectional view along a line A-A′ in FIG. 26A, and FIG. 26C is a cross-sectional view along a line B-B′ in FIG. 26A. In Embodiment 3, the lower layer electrode film dA of the data line d is formed only in the vicinity of the region in which the emitter is formed on the principal surface of the first insulating substrate SUB1. This lower layer electrode film dA is also formed by sputtering a conductive material which does not lead to insulation defects due to oxidation, such as platinum (Pt), gold (Au) or iridium (Ir). By forming the upper electrode film dB of the data line as a thick film of Ag paste, lower resistance is achieved. Also, by providing the extension dA′ in the lower layer electrode film dA, which extends on the emitter-forming region side, and directly forming the lower electrode dC of the emitter on the principal surface of the back substrate SUB1 in contact with this extension dA′, a high-quality tunnel film (third insulating film INS3) is formed. The remaining structure is identical to that of Embodiment 2, and its description will not be repeated.

The second insulating film INS2 (field insulating film) is formed by anodization surrounding the part to become the emitter, and the third insulating film INS3 (tunnel insulating film) is formed in the part to become the emitter on the upper surface of the lower electrode dC of the emitter, respectively. Also, although not shown, a metal film for forming the upper electrode AED of the emitter, is formed by sputtering iridium (Ir), platinum (Pt) or gold (Au), or two or more thereof, on the whole surface of the back panel substrate SUB1 to which these various film-forming treatments have been applied. Following this, as described for Embodiment 2 referring to FIGS. 24A-24C, the back panel is completed by separating adjacent scanning lines.

The display panel is completed by integrating the back panel and front panel in a one-piece structure via the sealing frame, and placing the interior under a vacuum. The image display device is obtained by combining this display panel with various drive circuits and other members.

According to the third embodiment, a lower resistance is achieved since the data line d has a double layer structure including the thick film dB formed by printing Ag paste, and the aluminum film dA.

Since the emitter ELS uses an aluminum film formed directly by evaporation method on the planarized surface of the first insulating substrate SUB1 as the lower electrode dC, its tunnel film (third insulating film INS3) is planarized, and the upper electrode formed thereupon is also a planarized, high quality film. Due to this, the emitter ELS can give a uniform electron emission.

In Embodiment 2 and Embodiment 3, although the upper layer electrode film dB extends over the principal surface of the first insulating substrate SUB1 from the lower layer electrode film dA with which it is electrically connected, to another lower layer electrode film dA adjacent to this lower layer electrode film dA, it is electrically isolated from the other lower layer electrode film dA. Therefore, considering the “region” extending between the pair of lower layer electrodes dA which are mutually adjacent on the principal surface of the first insulating substrate SUB1, the extension of the upper electrode film dB terminates within this “region”.

### Embodiment 4

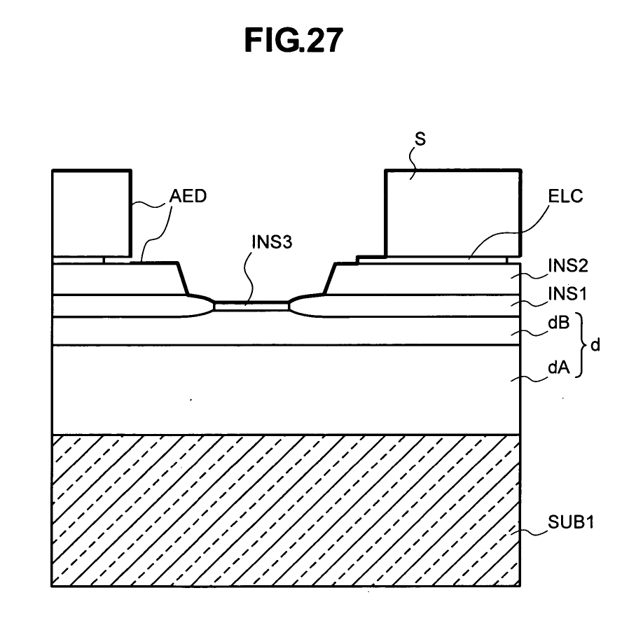

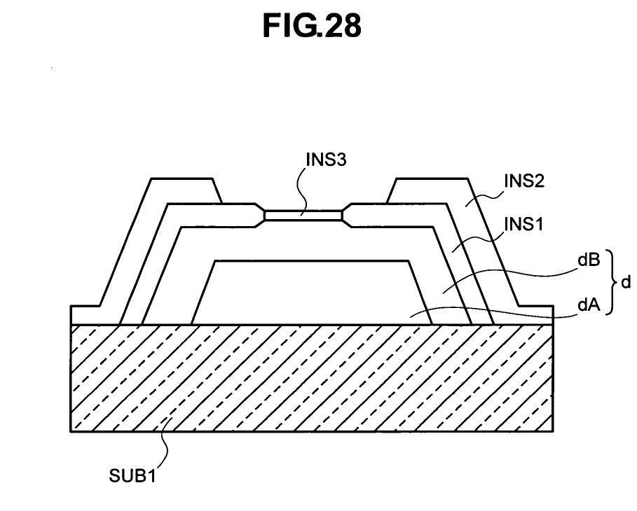

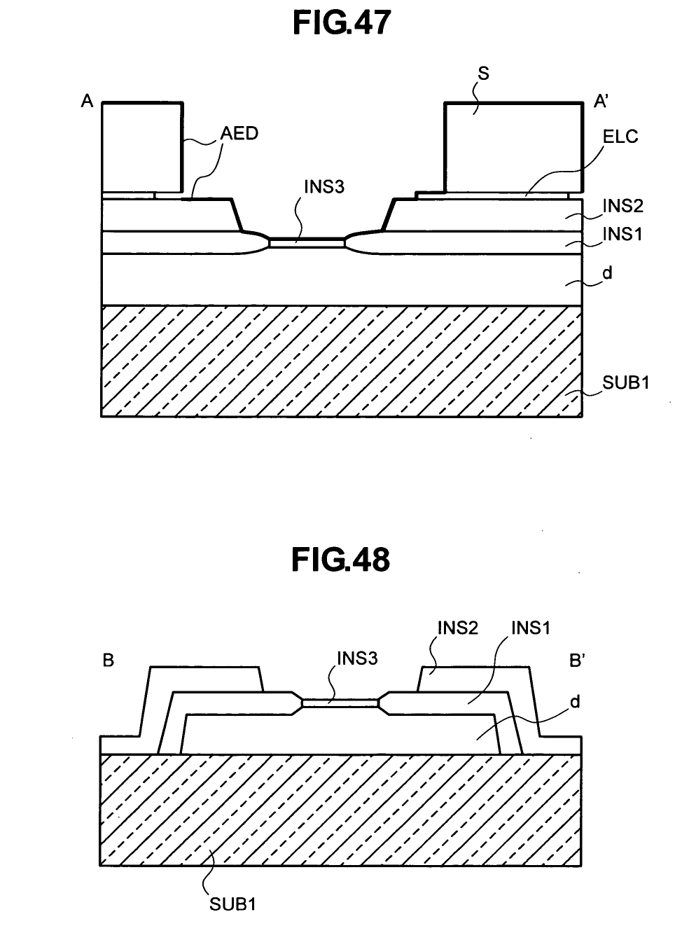

FIG. 27 is an enlarged cross-sectional view following FIG. 47 of the emitter part of the back panel for the purpose of describing a fourth embodiment of the image display device according to the invention. FIG. 28 is an enlarged cross-sectional view following FIG. 48 of the emitter part of the back panel for the purpose of describing the fourth embodiment of the image display device according to the invention. This back panel uses a glass plate as base member (hereafter, referred to as back plate SUB1), and the data line d, first insulating layer INS1, second insulating layer INS2, contact electrode ELC, scanning line s and upper electrode AED are laminated on its principal surface. The data line d has a double layer structure including the lower layer electrode dB formed by coating Ag paste, and the upper electrode dA including an alloy Al—Nd of aluminum and neodymium Nd.

The surface of the lower layer electrode dA is planarized by polishing, and the upper layer electrode dB formed as a layer above it (e.g., on the surface) by sputtering is a planarized film patterned after (e.g. having similar contour to) the surface contour of the lower layer electrode dA. If the principal surface of the underlayer of this upper layer electrode dB has irregularities due to the contour of the lower layer electrode dA or back plate SUB1, its upper surface will consequently also have irregularities, but its thickness is maintained relatively uniform regardless of the irregularities. The first insulating film INS1 and the third insulating film INS3 which is a tunnel insulating film are formed by anodization on the upper layer electrode dB. In particular, since the third insulating film INS3 is formed on the planarized upper layer electrode dB patterned after the surface of the lower layer electrode dA, the film quality is also high. The remaining structure is identical to that of FIG. 47 and FIG. 48.

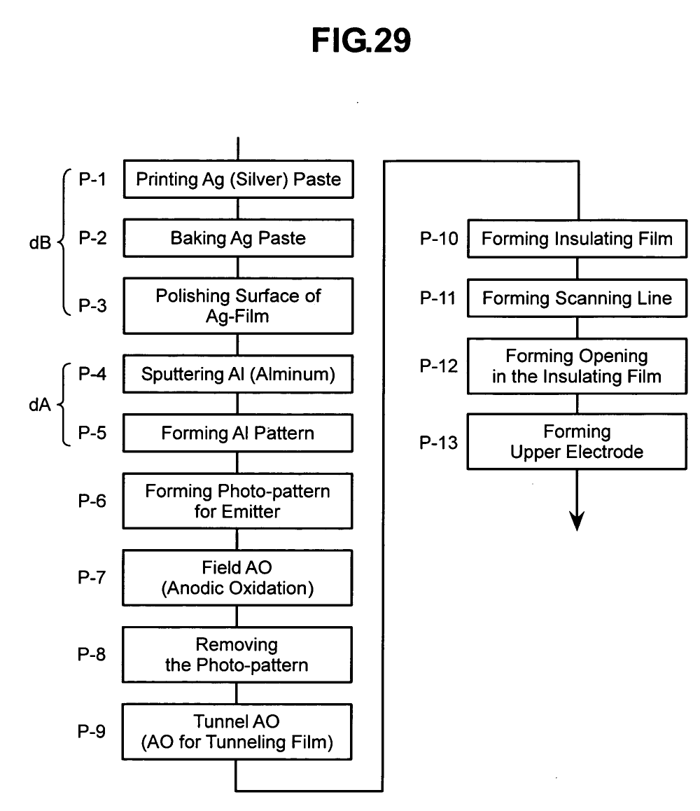

FIG. 29 is a diagram describing a process for manufacturing the fourth embodiment of the image display device according to the invention. The process for manufacturing the back panel shown in FIG. 27 and FIG. 28 will be described using FIG. 29. First, Ag paste is coated by printing the pattern of the lower layer electrode dA of the data line on the inner surface of the glass plate forming the back plate SUB1 (P-1). The Ag paste preferably contains frit glass. This is baked, solvent is cleaned off, and the frit glass is melted and solidified (P-2). The printing of the Ag paste may be performed by applying an overcoat on plural occasions so as to obtain the required film thickness.

The lower layer electrode dA is formed by polishing this surface by tape polishing using No. 3000-10000 polishing tape so that the surface roughness Rms does not exceed 5 nm (P-3). The polishing tape number is known also as the Tape Count, the polishing tape (polishing surface) being rougher, the smaller this value is. This polishing method is well-known by those skilled in the art, and polishing tape with abrasive particles such as alumina or the like can easily be procured. This lower layer electrode dA is covered by sputtering an aluminum film (P-4), and patterning is performed using photolithography so as to form the upper layer electrode dB (P-5). Here, the sputtering aluminum film was an aluminum-neodymium alloy. The upper layer electrode dB is preferably formed so as to cover the whole surface including the side surfaces of the lower electrode dA.

A photoresist is coated on the upper layer electrode dB, and patterning is performed so as to leave photoresist for anodization (AO) protection of the part to become the emitter (P-6). Next, the back plate SUB1 is dipped in an anodizing bath, and a field anodizing voltage is applied between the exposed part (field part) of the photoresist of the upper layer electrode dB and an electrode installed in the anodizing bath so as to form the first insulating layer INS1 (field AO), which is an anodized film of the upper layer electrode dB in this field part (P-7).

After removing the photoresist pattern for anodizing protection covering the part to become the emitter of the upper electrode dB (P-8), the back plate SUB1 is dipped in an anodizing bath wherein the anodizing voltage is set for tunnel AO, and the third insulating film INS3 which is a tunnel AO film is formed in the part to become the emitter (P-9). The second insulating layer INS2 for maintaining insulation from the scanning line is then formed over the whole region including the third insulating layer INS3 (P-10).

Next, the scanning line s is formed (P-11), and an opening is formed in the second insulating layer INS2 (P-12) to expose the third insulating layer INS3 and the required part of the surrounding area. Finally, using the exposed third insulating layer INS3 as a tunnel film, the upper electrode AED is formed on this tunnel film (P-13). The scanning line is covered by the contact electrode ELC preferably including an aluminum layer and chromium underneath this aluminum layer. On the emitter side, this contact electrode ELC has the function of ensuring electrical contact between the upper electrode AED and the scanning line, and on the opposite side to the emitter, has the additional function of isolating adjacent emitters in a self-adjusting way by etch back treatment.

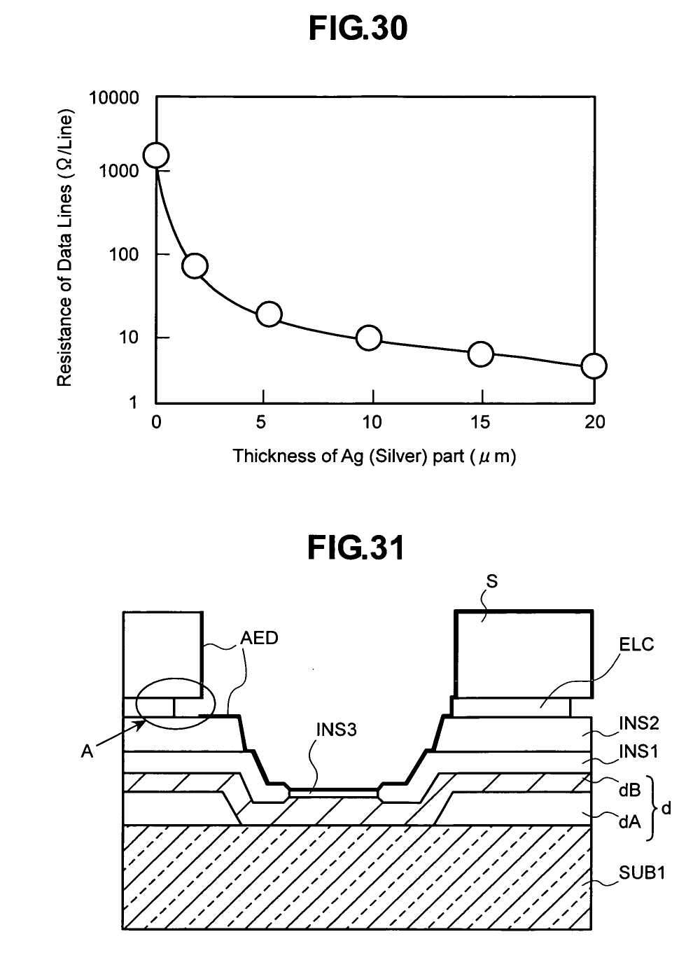

FIG. 30 is a diagram describing the resistance lowering of the data line relative to the film thickness of the lower layer electrode having a double layer structure. The resistance (Ω/line) of the data line (in FIG. 30, shown as data line) is 1000Ω/line or more in the case of the upper electrode alone, but when the lower layer electrode is provided by coating Ag paste, it becomes 100Ω/line for a film thickness of 2 μm or more, which is a very large reduction in resistance.

### Embodiment 5

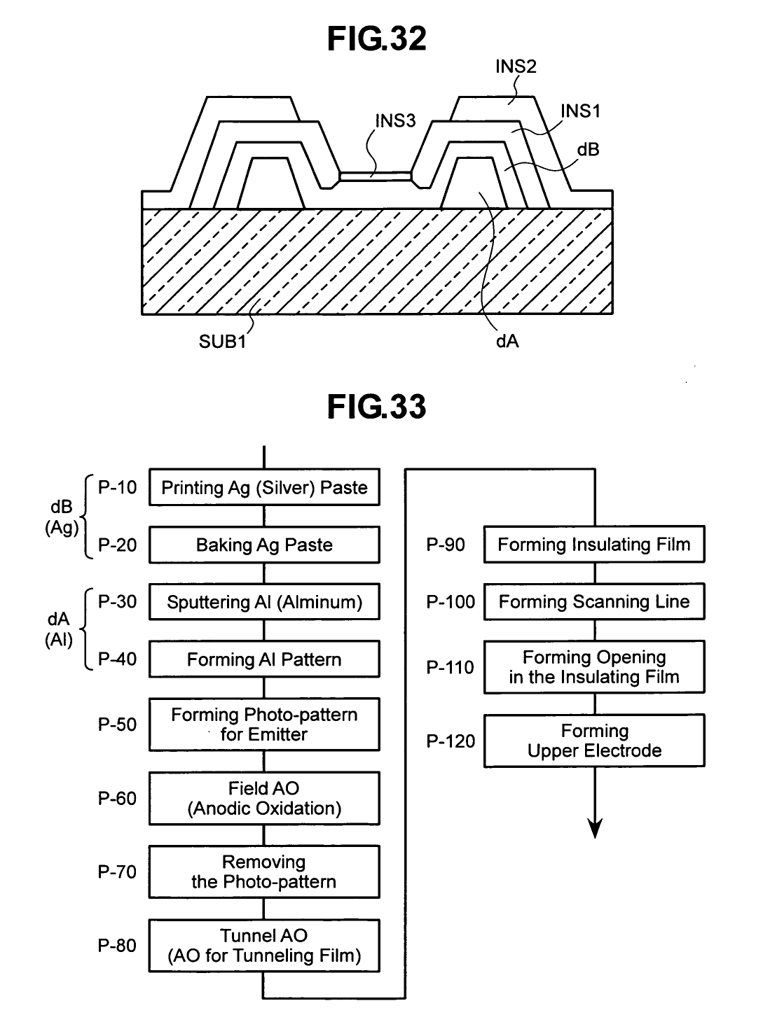

FIG. 31 is a cross-sectional view of a back panel identical to FIG. 27 showing the emitter part describing a fifth embodiment of the image display device according to the invention. FIG. 32 is a cross-sectional view of a back panel corresponding to FIG. 28 of the emitter part describing the fifth embodiment of the image display device according to the invention. As in the case of Embodiment 4, this back panel is a laminate of the data lined, first insulating layer INS1, second insulating layer INS2, contact electrode ELC, scanning line s, and upper electrode AED on the principal surface of a glass plate which is the back plate SUB1. The data line d has a double layer structure including the lower layer electrode dA formed by coating Ag paste, and the upper layer electrode dB including an alloy A—Nd of aluminum and neodymium Nd.

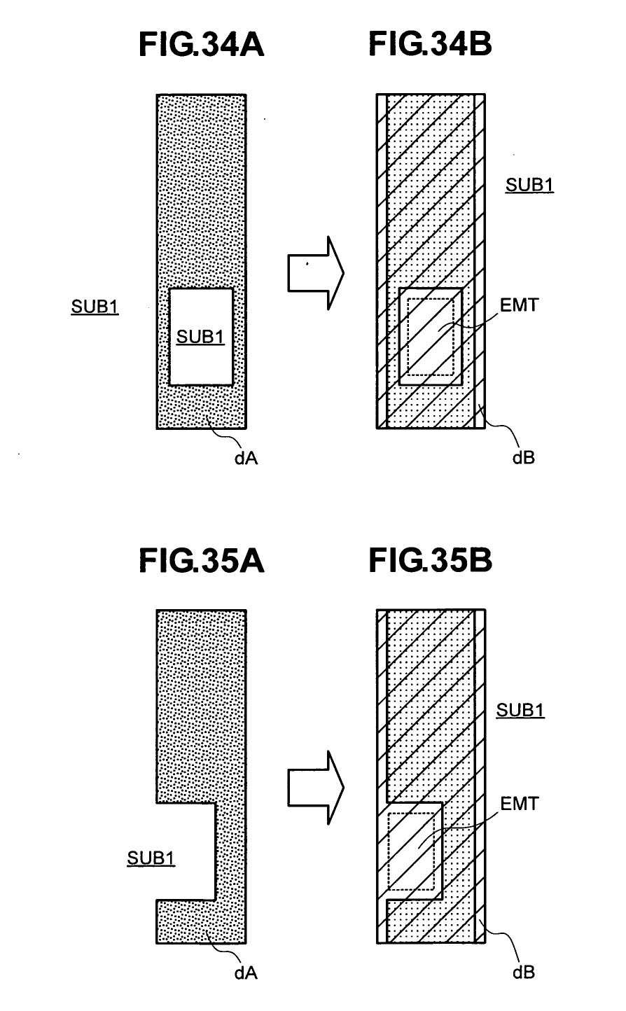

In Embodiment 4, the surface of the lower electrode dA which is in the emitter part, is planarized by polishing, and the upper layer electrode dB is formed as a layer above it by sputtering thereupon. On the other hand, in Embodiment 5, the lower layer electrode dA is not formed in the emitter part, and is formed directly on the surface of the back plate SUB1 which is originally a planarized surface. The upper electrode dB is a planarized film patterned after (having similar contour to) the surface contour of the black plate SUB1. The structure of this lower electrode dA and upper electrode dB will be described later in FIGS. 34A-36B.

In the upper layer electrode dB formed directly on the surface of the back plate SUB1, the first insulating film INS1 and third insulating film INS3 which is a tunnel insulating film, are formed by anodization. In particular, since the third insulating film INS3 is formed in the planarized upper layer electrode dB patterned after the surface of the plate SUB1, the film quality is also good. The remaining structure is identical to that of FIG. 27 and FIG. 28. According to the emitter of Embodiment 5, an image display device is obtained having data lines with a significantly greatly reduced wiring resistance (interconnection resistance), there is no unevenness in the emission due to the planarized surface, and film defects are suppressed so electron emission properties are good.

FIG. 33 is a diagram describing the manufacturing process of Embodiment 5 of the image display device according to the invention. FIG. 33 describes the process of manufacturing the back panel shown in FIG. 31 and FIG. 32. First, Ag paste is coated by printing on a pattern of the lower layer electrode dA of the data line on the inner surface of the glass plate forming the back plate SUB1 (P-10). At this time, the Ag paste is coated excepting in the emitter part. The Ag paste preferably contains frit glass. After coating, this is baked, the solvent is cleaned off, and the frit glass is melted and solidified (P-20). The printing of the Ag paste may also be repeated on plural occasions so as to obtain the required film thickness.

The surface of the lower electrode dA formed excepting in the emitter part and the back plate SUB1 of the emitter part is covered by sputtering an aluminum film (P-30), and patterning is performed using photolithography so as to form the upper electrode dB (P-40). Here, the sputtering aluminum film was an aluminum-neodymium alloy. The upper layer electrode dB is preferably formed to cover the whole surface including the side surfaces of the lower layer electrode dA.

A photoresist is coated on the upper layer electrode dB, and patterning is performed so as to leave photoresist for anodization (AO) protection in the part to become the emitter (P-50). This is dipped in an anodizing bath wherein the field voltage is set to form the first insulating layer INS1 (field AO), which is an anodizing film, in the field part (P-60).

The photoresist pattern for anodization protection which was in the part to become the emitter, is removed (P-70). The work piece is dipped in an anodizing bath where in the anodizing voltage is set to the tunnel AO, and the third insulating layer INS3, which is a tunnel AO, is formed in the emitter part (P-80). The second insulating layer INS2 is then formed over the whole region including the third insulating layer INS3 to ensure insulation from the scanning lines (P-90).

Next, the scanning line s is formed (P-100), and an opening is made in the second insulating layer INS2 (P110) to expose the third insulating layer INS3 and the required part of the surrounding area. Finally, using the exposed third insulating layer INS3 as a tunnel film, the upper electrode AED is formed on this tunnel film (P-120). The scanning line is covered by the contact electrode ELC preferably including an aluminum layer and chromium underneath this aluminum layer. On the emitter side, this contact electrode ELC has the function of ensuring electrical contact between the upper electrode AED and the scanning line, and on the opposite side to the emitter, has the additional function of isolating adjacent emitters in a self-adjusting way by etch back treatment. In Embodiment 5, it is not required to polish the lower layer electrode dA, and since the upper layer electrode dB is sputtered directly on the surface of the planarized back plate SUB1, high reliability is obtained and the number of manufacturing steps is reduced.

FIGS. 34A-34B are diagrams describing a first example of a data line in Embodiment 5 of the image display device according to the invention. In this example, the lower layer electrode dA is formed excepting in the part where the emitter is formed, i.e., the film-forming part of the third insulating layer (tunnel film) INS3 and its surrounding area (inclined surface-forming part of the upper electrode AED (FIG. 34A). The upper layer electrode is formed thereupon by sputtering aluminum or aluminum alloy. The emitter-forming part is shown by the dotted line (FIG. 34B).

Since the tunnel film (insulating layer INS3) of the emitter is formed by anodizing the upper layer electrode dB, the surface of the upper layer electrode dB is a planarized film patterned after the planarity of the surface of the back plate SUB1, and the tunnel film is free of any defects. The upper electrode AED is formed by sputtering a metal thin film, preferably gold, iridium or platinum, thereupon. According to the emitter manufactured in this way, the emitter has a data line with a significantly lowered wiring resistance (interconnection resistance), and since it has a planarized surface, there is no emission unevenness, film defects are suppressed and good electron emission properties are obtained.

FIGS. 35A-35B are diagrams showing a second example of the data line in Embodiment 5 of the image display device according to the invention. In this example, the lower layer electrode dA is formed excepting in the part where the emitter is formed, i.e., the film-forming part of the third insulating layer (tunnel film) INS3 and its surrounding area (inclined surface-forming part of the upper electrode AED (FIG. 35A). The upper layer electrode is formed thereupon by sputtering aluminum or aluminum alloy. The emitter-forming part is shown by the dotted line (FIG. 35B).

Since the tunnel film (insulating layer INS3) of the emitter is formed by anodizing the upper layer electrode dB, the surface of the upper layer electrode dB is a planarized film following the planarity of the surface of the back plate SUB1, and the tunnel film is free of any defects. The upper electrode AED is formed by sputtering a metal thin film, preferably gold, iridium, platinum or the like, thereupon. According to the emitter manufactured in this way, the emitter has a data line with a sufficiently reduced wiring resistance (interconnection resistance), and as it has a planarized surface, there is no emission unevenness, film defects are suppressed and good electron emission properties are obtained.

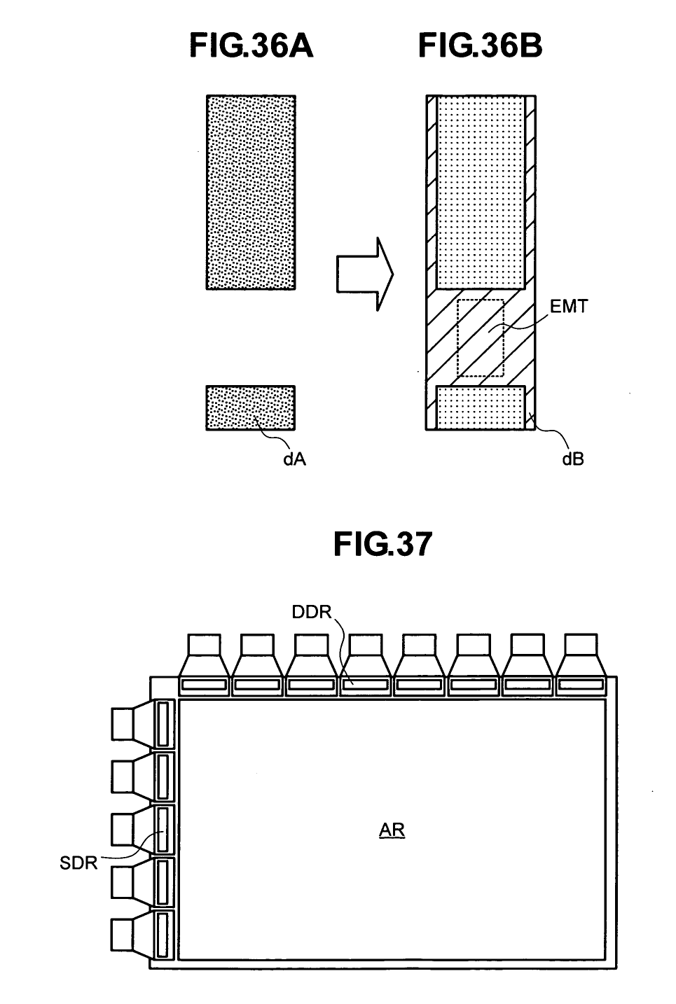

FIGS. 36A-36B are diagrams showing a third example of the data line in Embodiment 5 of the image display device according to the invention. In this example, the lower layer electrode dA is formed excepting in the part where the emitter is formed, i.e., the film-forming part of the third insulating layer (tunnel film) INS3 and its surrounding area (inclined surface-forming part of the upper electrode AED (FIG. 36A). The upper layer electrode is formed thereupon by sputtering aluminum or aluminum alloy. The emitter-forming part is shown by the dotted line (FIG. 36B).

In the third example also, as in the case of the first and second examples, since the tunnel film (insulating layer INS3) of the emitter is formed by anodizing the upper layer electrode dB, the surface of the upper layer electrode dB is a planarized film patterned after the planarity of the surface of the back plate SUB1, and the tunnel film is free of any defects. The upper electrode AED is formed by sputtering a metal thin film, preferably gold, iridium or platinum, thereupon. According to the emitter manufactured in this way, the emitter has a data line with a significantly lowered wiring resistance (interconnection resistance), and since it has a planarized surface, there is no emission unevenness, film defects are suppressed and good electron emission properties are obtained.

According to Embodiments 4 and 5 of the invention, the emitter has a data line with a significantly lowered wiring resistance (interconnection resistance), and since it has a planarized surface, there is no emission unevenness, film defects are suppressed, good electron emission properties are obtained, and a high quality image display device is obtained.

FIG. 37 is a schematic view of a display panel describing the effect of the invention. For a pixel region AR forming a large size screen, data drivers DDR need be installed only in one of the long sides outside the pixel region AR. If the scanning lines also have a double layer structure to lower the resistance, scanning drivers SDR also need the installed only in one of the short sides outside the pixel region AR.

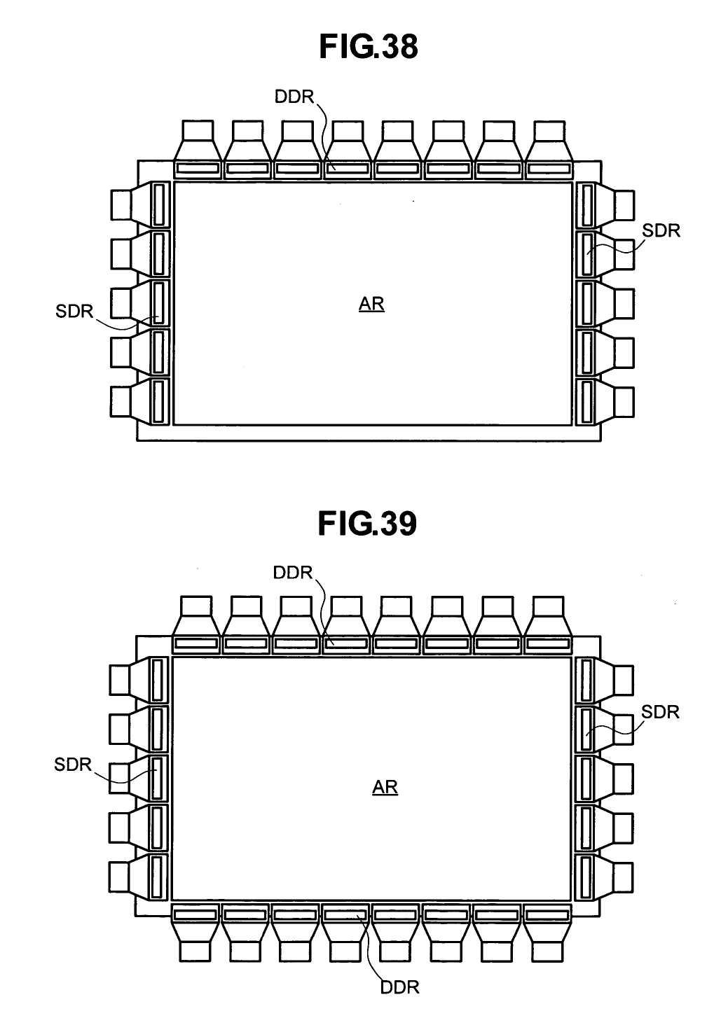

FIG. 38 is a schematic view of another display panel describing the effect of to the invention. For the pixel region AR forming a large size screen, the data drivers DDR need be installed only in one of the long sides outside the pixel region AR. The scanning lines have the structure of the prior art and do not have a low resistance, so the scanning drivers SDR are installed in both of the short sides of the pixel region AR.

FIG. 39 is a schematic view of a display panel according to the prior art for the purpose of describing the effect of to the invention. For the pixel region AR forming a large size screen, the data drivers DDR are installed in both of the long sides outside the pixel region AR, and the scanning drivers SDR are also installed in both of the short sides of the pixel region AR.

As is clear by comparing FIG. 37, FIG. 38 and FIG. 39, according to the invention, the number of drivers to be installed can be largely reduced which contributes greatly to cost reduction.

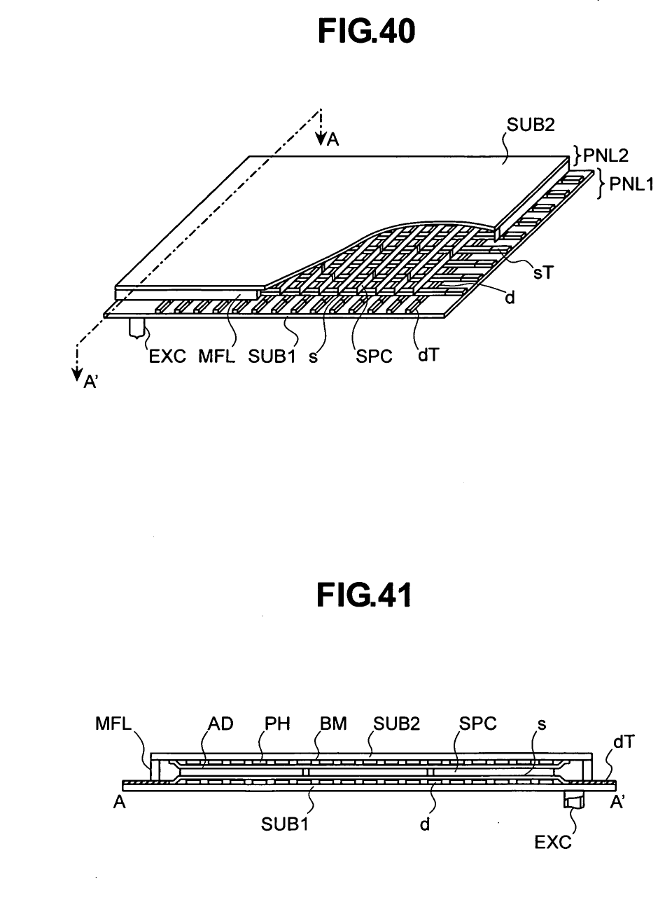

FIG. 40 is a perspective, partial cutaway view describing one example of the overall structure of the image display device according to the invention in more detail. FIG. 41 is a cross-sectional view along a line A-A′ in FIG. 40. As described earlier, the inner surface of the back plate SUB1 forming the back panel PNL1 has data lines d and scanning lines s of double layer structure, and emitters are formed in the vicinity of the intersections between the data lines d and scanning lines s. A data line extension dT is formed at one end of the data line d, and a scanning line extension sT is formed at one end of the scanning line s.

A black matrix BM, anode AD and phosphors PH are formed on the inner surface of a base member (hereafter, front plate) SUB2 forming the front panel PNL2. The back plate SUB1 forming the back panel PNL1 and the front plate SUB2 forming the front panel are stuck together via a sealing frame MFL interposed between their edges. The spacer SPC which is preferably a glass plate or ceramic plate is disposed between the back panel SUB1 and front panel PNL2 to maintain the gap therebetween at a predetermined value. FIG. 41 shows a cross section along the spacer SPC. The spacer SPC is fixed to stand on the principal surface of one of the back panel PNL1 (back plate SUB1) and front panel PNL2 (front plate SUB2). FIG. 41 shows three spacers standing next to each other along a scanning line s, but this arrangement is only an example.

The interior space sealed by the back panel PNL1, front panel PNL2 and frame glass MFL is evacuated by a vacuum tube EXC provided in part of the back panel PNL1, and maintained under a predetermined vacuum.

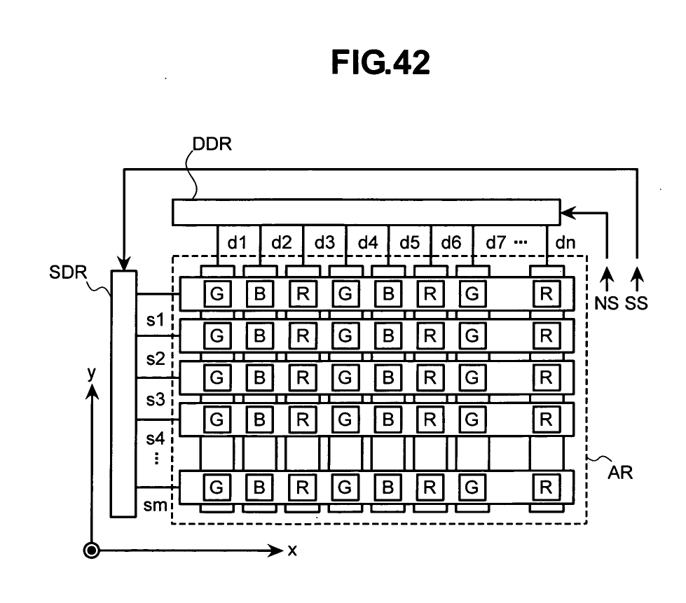

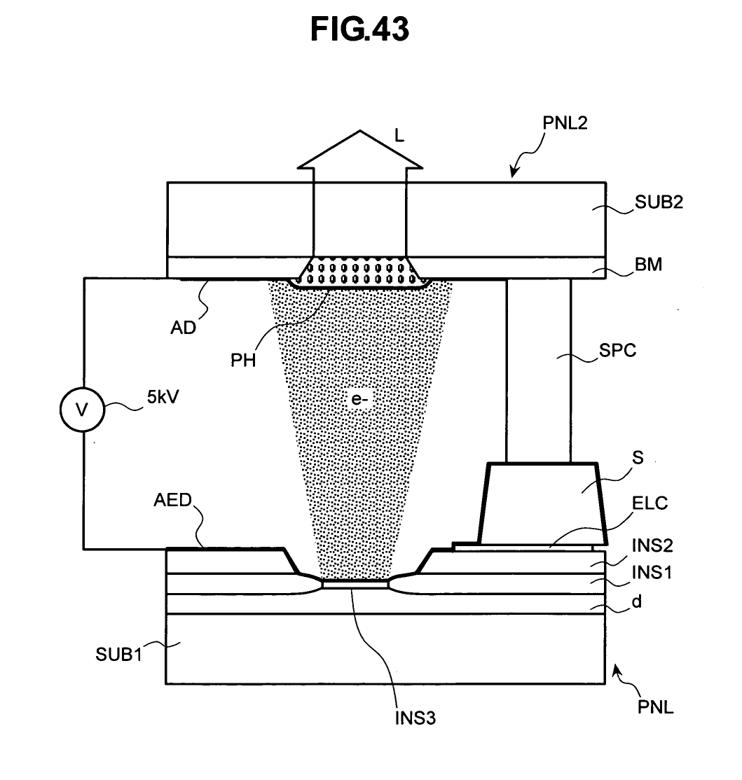

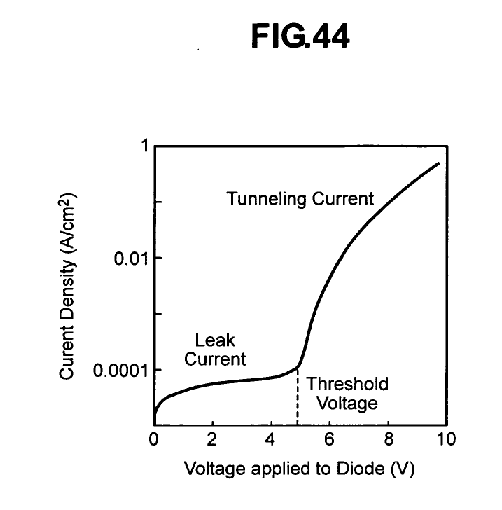

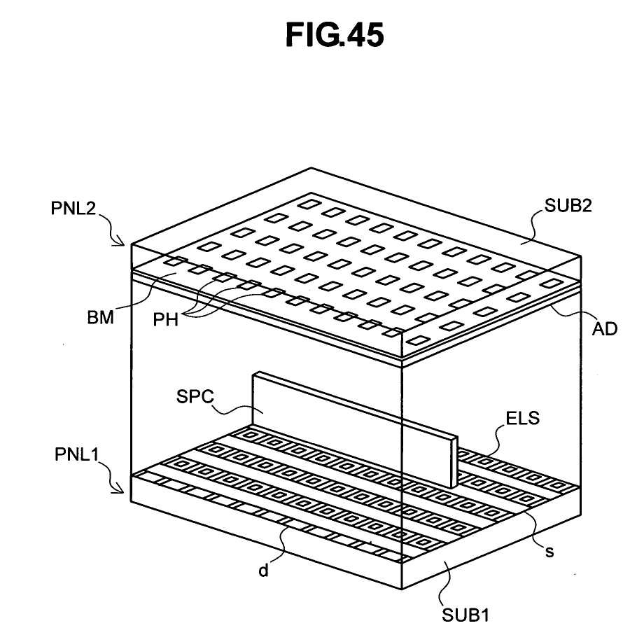

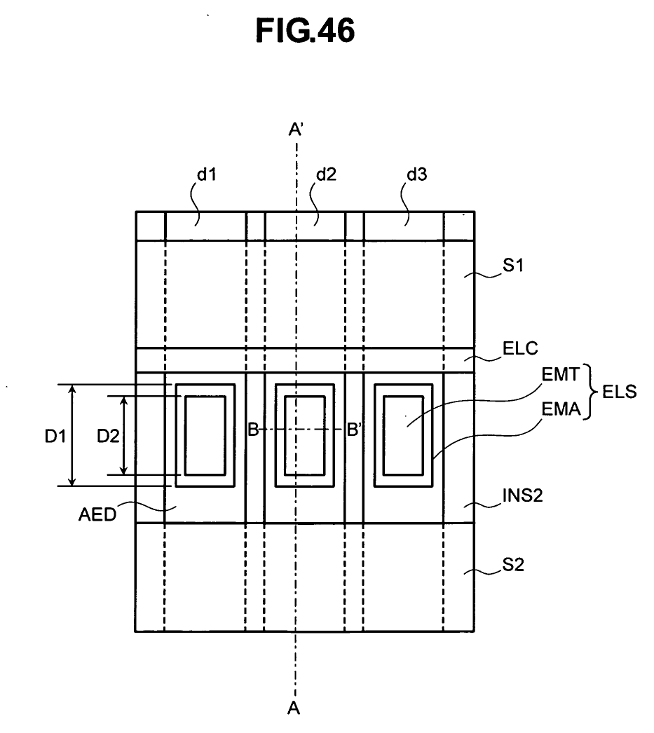

FIG. 42 is a diagram showing an example of an equivalent circuit of the image display device according to the invention. The region shown by the dotted line in FIG. 42 is the pixel region AR, the data lines d (d1, d2, d3, d4, d5, d6, d7, . . . dn) and scanning lines s (s1, s2, s3, s4, . . . sm) being disposed so that they mutually intersect to form a nxm matrix. The intersection parts of the matrix are sub-pixels, a group of three sub-pixels R, G, B in the diagram constituting one color pixel. The structure of the emitters is not shown. The data lines d are connected to the data line drive circuit (data drivers DDR), and the scanning lines s are connected to the scanning line drive circuit (scanning drivers SDR). An image signal NS is input to the data line drive circuit DDR from outside, and a scanning signal SS is likewise input to the scanning line drive circuit SDR.

In this way, by supplying an image signal from the data lines d to the sub-pixels connected to the scanning lines s which are selected in order, a two-dimensional color image can be displayed.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. An image display device, comprising:
a back panel including a plurality of scanning lines and a plurality of data lines on a planarized principal surface of a first insulating substrate, and a plurality of electron emitters arranged in a matrix in the vicinity of the intersections between the scanning lines and the data lines;
a front panel having phosphors respectively corresponding to the electron emitters on the planarized principal surface of a second insulating substrate, and an anode which accelerates an electron flux emitted from the electron emitters to collide with the phosphors,
a sealing frame interposed between the edges of the back panel and the front panel so as to form a vacuum enclosure together with the back panel and the front panel; and
a spacer disposed between the back panel and the front panel which maintains the distance between the two panels at a predetermined value, wherein:
a plurality of grooves are formed extending in one direction and juxtaposed in another direction intersecting perpendicularly therewith on the principal surface of the first insulating substrate forming the back panel,
the data lines include a lower layer electrode film filled in the grooves by printing and an upper layer electrode film covering the lower layer electrode film and being evaporated up to the planarized principal surface facing the grooves of the first insulating substrate; and
the electron emitters are formed on the planarized principal surface facing the grooves of the first insulating substrate of the upper layer electrode film.

2. The image display device according to claim 1, wherein the lower layer electrode film is a thick film formed by screen printing or slit printing of silver paste, and the upper layer electrode film is a thin film of aluminum or aluminum alloy formed by deposition method.

3. The image display device according to claim 2, wherein the electron emitters are thin film electron emitters having an aluminum or aluminum alloy thin film as a lower electrode thereof, an anodized film formed on the surface of the aluminum or aluminum alloy thin film as an insulating film thereof, and a noble metal thin film formed above the insulating film of the anodized film as an upper electrode thereof.

4. The image display device according to claim 3, wherein the lower electrode has a planarized surface patterned after the principal surface facing the groove of the first insulating substrate.

5. The image display device according to claim 1, wherein the upper electrode is connected to the scanning line.

6. An image display device, comprising:
a back panel including a plurality of scanning lines and a plurality of data lines on a planarized principal surface of a first insulating substrate, and a plurality of electron emitters arranged in a matrix in the vicinity of the intersections between the scanning lines and the data lines;
a front panel having phosphors respectively corresponding to the electron emitters on the planarized principal surface of a second insulating substrate, and an anode which accelerates an electron flux emitted from the electron emitters so that it collides with the phosphors;
a sealing frame interposed between the edges of the back panel and the front panel so as to form a vacuum enclosure together with the back panel and the front panel; and
a spacer disposed between the back panel and the front panel which maintains the distance between the two panels at a predetermined value, wherein:
the data line is configured with a double layer film including a lower layer wiring film of a conductive thin film having an extension part extended into an area where one of the electron emitters is formed, and an upper layer wiring film formed by a printing method on the lower layer wiring film other than the extension part of the lower layer wiring film; and
the electron emitter includes a lower electrode which is a thin film electrode formed directly on the surface of the first insulating substrate in contact with the lower layer wiring film.

7. The image display device according to claim 6, wherein the lower layer wiring film is a thin film of conductive material which does not lead to insulation defects due to oxidation, such as platinum, gold or iridium, and the upper layer electrode film is a thick film formed by screen printing of silver paste.

8. The image display device according to claim 7, wherein the electron emitters are configured with thin film electron emitters each having an aluminum or aluminum alloy a part of which is formed to be superimposed on a part of the lower layer wiring film as a lower electrode thereof, an anodized film formed on the surface of the aluminum or aluminum alloy as an insulating film thereof, and a noble metal thin film formed above the insulating film of the anodized film as an upper electrode thereof.

9. The image display device according to claim 6, wherein the lower electrode has a planarized surface patterned after the surface of the first insulating substrate.

10. The image display device according to claim 8, wherein the upper electrode is connected to the scanning line.

11. An image display device, comprising:
a back panel including a plurality of scanning lines and a plurality of data lines on a planarized principal surface of a first insulating substrate, and a plurality of electron emitters arranged in a matrix in the vicinity of the intersections between the scanning lines and the data lines;
a front panel having phosphors respectively corresponding to the electron emitters on the planarized principal surface of a second insulating substrate, and an anode which accelerates an electron flux emitted from the electron emitters so that it collides with the phosphors;
a sealing frame interposed between the edges of the back panel and the front panel so as to form a vacuum enclosure together with the back panel and the front panel; and
a spacer disposed between the back panel and the front panel which maintains the distance between the two panels at a predetermined value, wherein:
the data lines are formed by a wiring film formed by a printing method, and include a thin film contact electrode which extends into an electron emitter-forming part; and
the electron emitters are formed above a lower electrode, wherein a thin film electrode formed directly on the surface of the first insulating substrate in contact with the thin film contact electrode as the lower electrode thereof.

12. The image display device according to claim 11, wherein the thin film contact electrode is a thin film of a conductive material which does not lead to insulation defects due to oxidation, such as platinum, gold or iridium, and the wiring film forming the data lines is a thick film formed by printing of silver paste.

13. The image display device according to claim 12, wherein the electron emitters are configured with thin film electron emitters each having a thin film of aluminum or aluminum alloy formed partly superimposed on a lower layer electrode film as a lower electrode thereof, an anodizing film formed on the surface of the aluminum or aluminum alloy thin film as an insulating film thereof, and a noble metal thin film formed above the insulating film of the anodized film as an upper electrode thereof.

14. The image display device according to claim 11, wherein the lower electrode has a planarized surface patterned after the surface of the first insulating substrate.

15. The image display device according to claim 11, wherein the upper electrode is connected to the scanning line.

16. An image display device, comprising:
a back panel including a plurality of electron emitters arranged in a matrix in a display region on a planarized principal surface of a first insulating substrate, and;
a front panel having phosphors respectively corresponding to the electron emitters on the planarized principal surface of a second insulating substrate, and an anode which accelerates an electron flux emitted from the electron emitters so that it collides with the phosphors;
a sealing frame interposed between the edges of the back panel and the front panel so as to form a vacuum enclosure together with the back panel and the front panel; and
a spacer disposed between the back panel and the front panel which maintains the distance between the two panels at a predetermined value, wherein:
the first insulating substrate forming the back panel has a plurality of scanning lines extending in a first direction and juxtaposed in a second direction transverse to the first direction, a plurality of data lines extending in the second direction and juxtaposed in the first direction so as to intersect with the scanning lines, and the electron emitters provided at the intersections between the scanning lines and the data lines, and
the data lines are two types of conductive materials different from each other and different in film thickness thereof.

17. The image display device according to claim 16, wherein, at least in the display region, the two types of conductive materials of different thickness configure a double layered-structure over the whole region including areas where the electron emitters are formed.

18. The image display device according to claim 16, wherein, the data lines formed of the two types of conductive materials are configured with a single layered-structure in areas where the electron emitters are formed, and configured with a double layered-structure in other areas except for the area, at least in the display region.

19. The image display device according to claim 16, wherein the thicker film of the two types of conductive materials is a coating film, and the thinner film thereof is a evaporated film.

20. The image display device according to claim 17, wherein one film of the double layered-structure in contact with the first insulating substrate is a thick coating film, and another film of the double layered-structure is evaporated to cover the coating film.

21. The image display device according to claim 18, wherein one layer of the double layered-structure in contact with the first insulating substrate in the other area except for the area where the electron emitter is formed is a thick coating film, and another layer of the double layered-structure thinner than the one layer thereof is evaporated to be in contact with the first insulating substrate in the area where the electron emitter is formed and covers the coating film in the other area except for the area where the electron emitter is formed.

22. The image display device according to claim 20, wherein the surface of the coating film is planarized, and the evaporated film has a planarized surface patterned after the surface of the coating film.

23. The image display device according to claim 21, wherein the evaporated film in contact with the first insulating substrate in the area where the electron emitter is formed has a planarized surface patterned after the surface of the first insulating substrate.

24. The image display device according to claim 16, wherein the electron emitter includes a lower electrode formed by deposition of one of the two types of conductive materials forming the data line, an insulating film laminated on the lower electrode and thinned in a part thereof which is an electron emission region emitting electrons so as to form an electron emitter opening, and an upper electrode in contact with the scanning line and covering the insulating film including the thinned part.

25. The image display device according to claim 26, wherein the spacer is disposed above the scanning line and along this scanning line.
